(19) United States
(12) Patent Application Publication
(10) Pub. No.: US 2013/0089076 A1
(43) Pub. Date: Apr. 11, 2013

(54) LOCAL / REMOTE IP TRAFFIC ACCESS AND SELECTIVE IP TRAFFIC OFFLOAD SERVICE CONTINUITY

(71) Applicants: Ulises Olvera-Hernandez, Kirkland (CA); Pascal M. Adjakple, Great Neck, NY (US); Saad Ahmad, Montreal (CA); Peter S. Wang, E. Setauket, NY (US); Mahmoud Watfa, Saint Leonard (CA); Kai Liu, S. Huntington, NY (US)

(72) Inventors: Ulises Olvera-Hernandez, Kirkland (CA); Pascal M. Adjakple, Great Neck, NY (US); Saad Ahmad, Montreal (CA); Peter S. Wang, E. Setauket, NY (US); Mahmoud Watfa, Saint Leonard (CA); Kai Liu, S. Huntington, NY (US)

(73) Assignee: INTERDIGITAL PATENT HOLDINGS, INC., Wilmington, DE (US)

(21) Appl. No.: 13/436,827

(22) Filed: Mar. 30, 2012

Related U.S. Application Data
(60) Provisional application No. 61/471,002, filed on Apr. 1, 2011.
(60) Provisional application No. 61/471,621, filed on Apr. 4, 2011.
(60) Provisional application No. 61/483,494, filed on May 6, 2011.
(60) Provisional application No. 61/544,911, filed on Oct. 7, 2011.

(51) Int. Cl. H04W 36/22

(52) U.S. Cl. CPC H04W 36/22
USPC 370/332; 370/331; 370/328

(57) ABSTRACT

Disclosed herein are systems and methods for handling closed subscriber group (CSG) based local/remote IP traffic offload and selective IP traffic offload. According to an aspect, a method may be implemented at user equipment (UE). The method may include determining that a service to the UE requires a predetermined quality of service (QoS). The method may also include selecting a gateway from among a plurality of gateways in response to determining that the service to the UE requires the predetermined QoS.

### CROSS REFERENCE TO RELATED APPLICATIONS

This application claims the benefit of U.S. Provisional Application No. 61/471,002, filed Apr. 1, 2011 (Attorney Ref. No. 10980); U.S. Provisional Application No. 61/471,621, filed Apr. 4, 2011 (Attorney Ref. No. 10987); U.S. Provisional Application No. 61/483,494, filed May 6, 2011 (Attorney Ref. No. 11043); and U.S. Provisional Application No. 61/544,911, filed Oct. 7, 2011 (Attorney Ref. No. 11181); which are incorporated herein by reference as if fully set forth herein.

### BACKGROUND

Local Gateways (LGWs) and Home evolved Node B (H(e)NB) have generally been co-located within the same node in a network. The introduction of a standalone LGW may enable mobility for Local IP Access (LIPA) and Selective IP Traffic Offload (SIPTO) at a local network. However, connection between the H(e)NB and LGW is no longer trivial, since the LGW and H(e)NB do not necessarily know each other IP address. Therefore as the system is being build up and new nodes are powered up, there must be a means for these LGWs and H(e)NB to discover each other.

Additionally, a subscriber may wish to avail of IP traffic offload points that suit particular requirements of a service he/she requests. The current granularity that the system offers is on a per APN basis. This does not allow providing SIPTO specific differentiated service capabilities using the same APN. Moreover, APN basis SIPTO association does not allow user-based preference configuration for SIPTO (or LIPA) services, location awareness association, dynamic/on-the-fly or static billing regime driven SIPTO service selection. Furthermore, the current systems do not allow for seamless mobility using SIPTO or LIPA.

### SUMMARY

Disclosed herein are systems and methods for handling closed subscriber group (CSG) based local/remote IP traffic offload and selective IP traffic offload. The embodiments may be used, for example, to allow a subscriber may to use IP traffic offload points that suit a particular requirement of a service he/she requests. Additionally, the embodiments allow for providing SIPTO specific differentiated service capabilities using the same APN and my allow for user-based preference configuration for SIPTO (or LIPA) services, location awareness association, dynamic/on-the-fly or static billing regime driven SIPTO service selection. Furthermore, the embodiments provide for seamless mobility using SIPTO or LIPA.

According to an aspect, a method may be used to select a target HeNB for a handover. A connection may be established with a wireless transmit/receive unit (WTRU). The connection may be a session, wherein the session may comprise any of a selective IP traffic offload (SIPTO) or local IP access (LIPA) session. A target HeNB may be selected for the handover based on the ability of the target HeNB to support the session. The session may be handed over to the target HeNB.

According to another aspect, a WTRU may enable a LGW to distinguish between SIPTO and LIPA. An inter-access point name (APN) routing policy (IARP) that may provide a set of rules for routing UIP traffic across one or more active interfaces may be received. A preferred APN may be determined using a prioritized list of APNs from the IARP. An IP interface may be selected to route an IP flow based on the preferred APN. The IP flow may be transmitted using the selected IP interface.

According to another aspect, a method may be used to provide a handover. A HeNB may receive a handover indication. A determination may be made as to whether a connection to a WTRU may be established that may support a session. The session may comprise any of a SIPTO or LIPA session. A connection may be established with the WTRU. A session handover may be received.

According to an aspect, a method may be implemented at user equipment (UE). The method may include determining that a service to the UE requires a predetermined quality of service (QoS). The method may also include selecting a gateway from among a plurality of gateways in response to determining that the service to the UE requires the predetermined QoS.

According to another aspect, a method may be implemented at a UE. The method may include receiving user selection of a closed subscriber group identifier (CSG ID). The method may also include implementing traffic offload to a gateway associated with the CSG ID in response to receipt of the user selection.

Additionally, disclosed herein are systems and methods for providing mobility and services continuity for LIPA and SIPTO. The embodiments may be applicable to Home Node B (HNB) or Evolved-UTRAN Home Node B (HeNB) subsystems. Accordingly, herein the term HNB may be used interchangeably with HeNB or H(e)NB. The embodiments may provide for HO via S1 or X2 interfaces.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1A is a system diagram of a communications system in which one or more disclosed embodiments may be implemented.

FIG. 1B is a system diagram of a wireless transmit/receive unit (WTRU) that may be used within the communications system illustrated in FIG. 1A.

FIG. 1C is a system diagram of a radio access network and a core network that may be used within the communications system illustrated in FIG. 1A.

FIG. 1D is a system diagram of a radio access network and another core network that may be used within the communications system illustrated in FIG. 1A.

FIG. 1E is a system diagram of a radio access network and another core network that may be used within the communications system illustrated in FIG. 1A.

FIG. 2 depicts a block diagram of a communications network may provide Closed Subscriber Group (CSG) based Local IP Access (LIPA), Remote IP Access (RIPA), and/or Selective IP Traffic Offload (SIPTO).

FIG. 3 depicts a block diagram of a communications network that may provide SIPTO and/or LIPA mobility in a Local Gateways (LGW) architecture.

FIG. 4 depicts a block diagram of a communications network where a LGW may be collocated with a H(e)NB.

FIG. 5 depicts a block diagram of a communications network that may provide access to a local IP network through the use of a LGW.

FIG. 6 depicts a block diagram of a communications network where a user equipment (UE) may maintain a connection to a LGW while being handed off to a H(e)NB.

FIG. 7 depicts a block diagram of a communications network where a network operator may choose a public data network (PDN) gateway (GW) to offload traffic.

FIG. 8 depicts a block diagram of a communications network that may offload user data using a LGW.

FIG. 9 depicts a method that may be used to inform a mobility management entity (MME) about LGW deployment during a hand off.

FIG. 10 depicts a communications network that may handle release LIPA and/or SIPTO resources between a source H(e)NB and a LGW after a hand off.

FIG. 11 depicts a communications network that may page a UE for LIPA and/or SIPTO at LGW traffic.

### DETAILED DESCRIPTION

Disclosed herein are systems and methods for handling closed subscriber group (CSG) based local/remote IP traffic offload and selective IP traffic offload. According to an aspect, a method may be implemented at user equipment (UE). The method may include determining that a service to the UE requires a predetermined quality of service (QoS). The method may also include selecting a gateway from among a plurality of gateways in response to determining that the service to the UE requires the predetermined QoS.

The current effort for the 3GPP Long Term Evolution (LTE) program is to bring new technology, new architecture, and new techniques in the new LTE setting and configurations to provide improved spectral efficiency, reduced latency, and better utilization of the radio resources to bring faster user experiences and richer applications and services with less cost.

As part of these efforts, the 3GPP has introduced the concept of a home node B or home enhanced Node B (HeNB) in LTE (and also, possibly in other cellular standards). The HeNB may refer to a physical device similar to a wireless local area network (WLAN) access point (AP). The HeNB my provide users with access to LTE services over small service areas, such as homes or small offices. The HeNB may be intended to connect to an operators' core network by using, for example, public Internet connections. This may be particularly useful in areas where LTE may not have been deployed and/or legacy 3GPP radio access technology (RAT) coverage may already exist. This may also be useful in areas where LTE coverage may be faint or non-existent for radio transmission problems that occur, for example, while in an underground metro or a shopping mall.

A cell may refer to the area over which radio coverage provided by the HeNB is available. The cell deployed by the HeNB may be accessed only by a group of subscribers who have access to the services of the cell (e.g., a family) and such a cell may be referred to as a HeNB cell, or more commonly, a closed subscriber group (CSG) cell. A HeNB may be used to deploy one or more CSG cells over the area which LTE coverage is desired. The term CSG call may be used for a cell deployed by a HeNB for LTE services or by a HNB for WCDMA or other legacy 3GPP RAT services.

The HeNB may support remote access for a CSG member to the home based network from a wireless transmit/receive unit (WTRU) or user equipment (UE) via public land mobile network (PLMN) in order to provide access to IP capable devices connected to the home based network. Access to the home based network may be restricted on per-subscriber basis. Further, the HPLMN may provide the visited PLMN (VPLMN) with the following information for a particular user: (1) an indication of whether the user's IP traffic is permitted to be subjected to Selected IP Traffic Offload in the visited network; and (2) the defined IP for which the selected IP traffic offload is permitted. Architectural aspects for local IP access (LIPA) and selected IP traffic offload (SIPTO) at the local network may include the support of mobility for LIPA between HeNBs located at the local network using a stand-alone local gateway separate from the HeNB to which the UE is attached.

Considering aspects of the functions described above, it may be likely that a user would like to access his/her local devices regardless of whether this user is at home or a visited network. In addition, a user may not be able to configure or may not be willing to configure or define LIPA or SIPTO parameters required for the correct determination of the correct or optimal offload point.

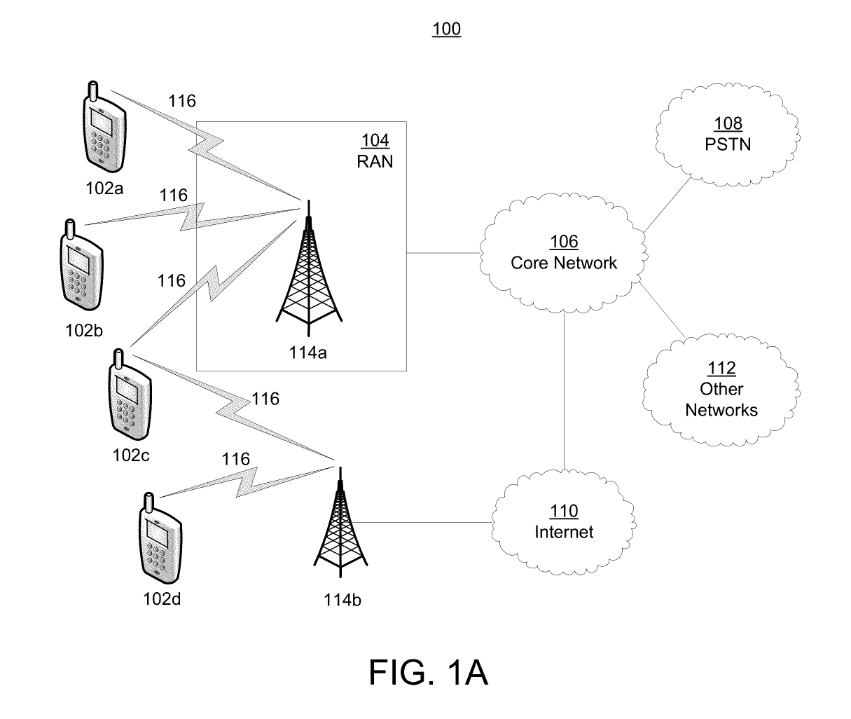

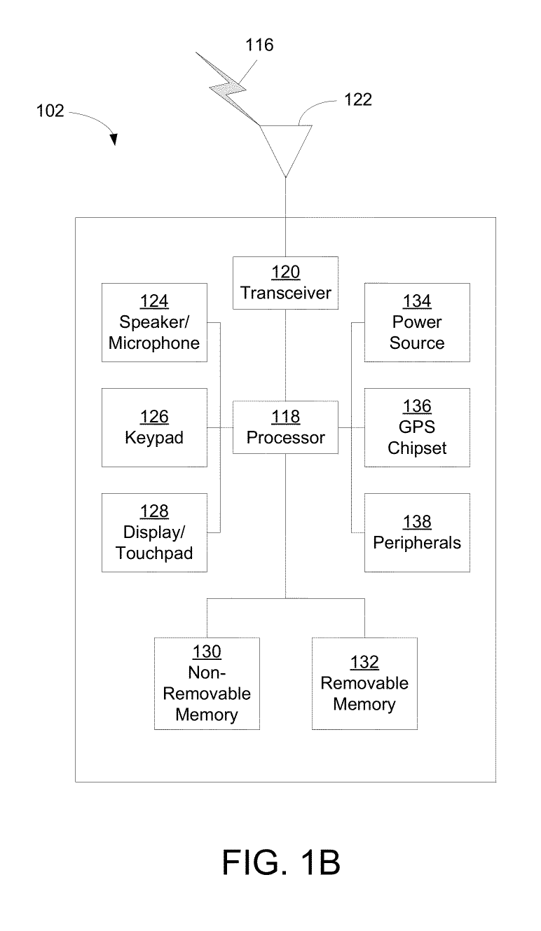

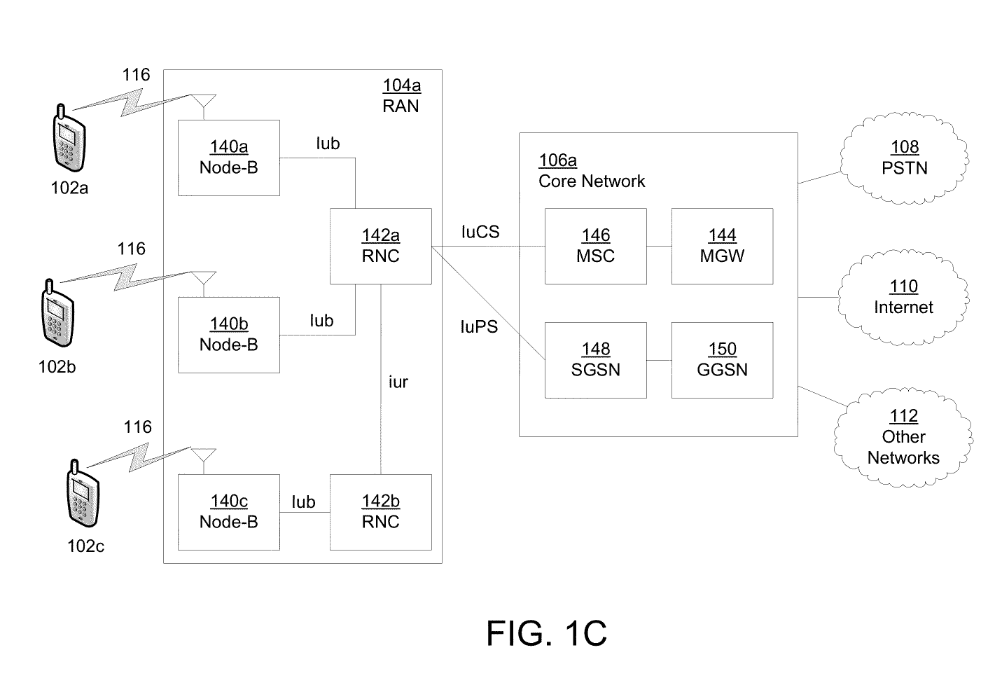

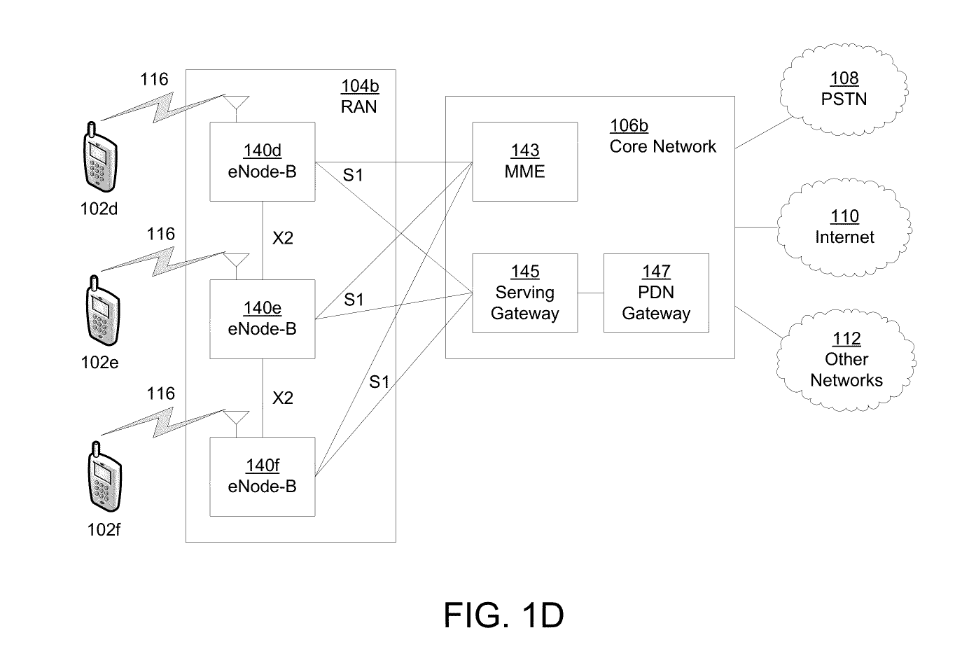

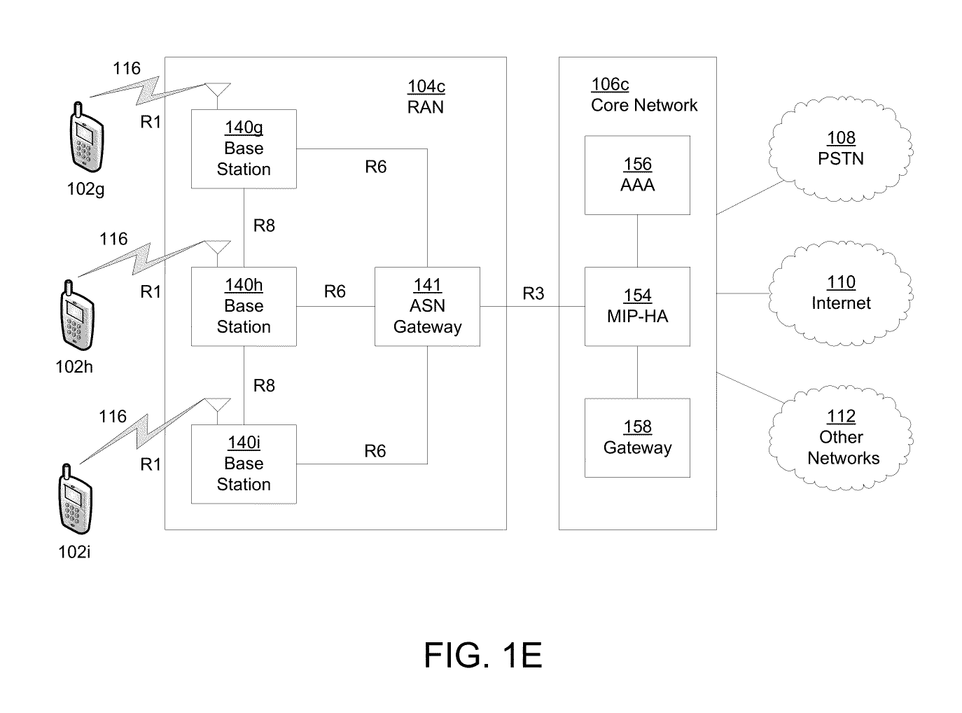

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106a according to an embodiment. As noted above, the RAN 104 may employ a UTRA radio technology to communicate with the WTRUs 102a, 102b, 102c over the air interface 116. The RAN 104 may also be in communication with the core network 106a. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106a shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106a, it will be appreciated that any one of these elements may be owned and/or operated by an entity other than the core network operator.

The RNC 142a in the RAN 104 may be connected to the MSC 146 in the core network 106a via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106a via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106a may also be connected to the networks 112, which may include other wired or wireless networks that are owned and/or operated by other service providers.

FIG. 1D is a system diagram of the RAN 104b and the core network 106b according to an embodiment. As noted above, the RAN 104b may employ an E-UTRA radio technology to communicate with the WTRUs 102d, 102e, 102f over the air interface 116. The RAN 104 may also be in communication with the core network 106b.

The RAN 104 may include eNode-Bs 140d, 140e, 140f, though it will be appreciated that the RAN 104 may include any number of eNode-Bs while remaining consistent with an embodiment. The eNode-Bs 140d, 140e, 140f may each include one or more transceivers for communicating with the WTRUs 102d, 102e, 102f over the air interface 116. In one embodiment, the eNode-Bs 140d, 140e, 140f may implement MIMO technology. Thus, the eNode-B 140d, for example, may use multiple antennas to transmit wireless signals to, and receive wireless signals from, the WTRU 102d.

Each of the eNode-Bs 140d, 140e, 140f may be associated with a particular cell (not shown) and may be configured to handle radio resource management decisions, handover decisions, scheduling of users in the uplink and/or downlink, and the like. As shown in FIG. 1D, the eNode-Bs 140d, 140e, 140f may communicate with one another over an X2 interface.

The core network 106b shown in FIG. 1D may include a mobility management gateway (MME) 143, a serving gateway 145, and a packet data network (PDN) gateway 147. While each of the foregoing elements are depicted as part of the core network 106b, it will be appreciated that any one of these elements may be owned and/or operated by an entity other than the core network operator.

The MME 143 may be connected to each of the eNode-Bs 140d, 140e, 140f in the RAN 104b via an S1 interface and may serve as a control node. For example, the MME 143 may be responsible for authenticating users of the WTRUs 102d, 102e, 102f, bearer activation/deactivation, selecting a particular serving gateway during an initial attach of the WTRUs 102d, 102e, 102f, and the like. The MME 143 may also provide a control plane function for switching between the RAN 104b and other RANs (not shown) that employ other radio technologies, such as GSM or WCDMA.

The serving gateway 145 may be connected to each of the eNode Bs 140d, 140e, 140f in the RAN 104b via the S1 interface. The serving gateway 145 may generally route and forward user data packets to/from the WTRUs 102d, 102e, 102f. The serving gateway 145 may also perform other functions, such as anchoring user planes during inter-eNode B handovers, triggering paging when downlink data is available for the WTRUs 102d, 102e, 102f, managing and storing contexts of the WTRUs 102d, 102e, 102f, and the like.

The serving gateway 145 may also be connected to the PDN gateway 147, which may provide the WTRUs 102d, 102e, 102f with access to packet-switched networks, such as the Internet 110, to facilitate communications between the WTRUs 102d, 102e, 102f and IP-enabled devices.

The core network 106b may facilitate communications with other networks. For example, the core network 106b may provide the WTRUs 102d, 102e, 102f with access to circuit-switched networks, such as the PSTN 108, to facilitate communications between the WTRUs 102d, 102e, 102f and traditional land-line communications devices. For example, the core network 106b may include, or may communicate with, an IP gateway (e.g., an IP multimedia subsystem (IMS) server) that serves as an interface between the core network 106b and the PSTN 108. In addition, the core network 106b may provide the WTRUs 102d, 102e, 102f with access to the networks 112, which may include other wired or wireless networks that are owned and/or operated by other service providers.

FIG. 1E is a system diagram of the RAN 104c and the core network 106c according to an embodiment. The RAN 104c may be an access service network (ASN) that employs IEEE 802.16 radio technology to communicate with the WTRUs 102g, 102h, 102i over the air interface 116. As will be further discussed below, the communication links between the different functional entities of the WTRUs 102g, 102h, 102i, the RAN 104c, and the core network 106c may be defined as reference points.

As shown in FIG. 1E, the RAN 104c may include base stations 140g, 140h, 140i, and an ASN gateway 141, though it will be appreciated that the RAN 104 may include any number of base stations and ASN gateways while remaining consistent with an embodiment. The base stations 140g, 140h, 140i may each be associated with a particular cell (not shown) in the RAN 104c and may each include one or more transceivers for communicating with the WTRUs 102g, 102h, 102i over the air interface 116. In one embodiment, the base stations 140g, 140h, 140i may implement MIMO technology. Thus, the base station 140g, for example, may use multiple antennas to transmit wireless signals to, and receive wireless signals from, the WTRU 102g. The base stations 140g, 140h, 140i may also provide mobility management functions, such as handoff triggering, tunnel establishment, radio resource management, traffic classification, quality of service (QoS) policy enforcement, and the like. The ASN Gateway 141 may serve as a traffic aggregation point and may be responsible for paging, caching of subscriber profiles, routing to the core network 106c, and the like.

The air interface 116 between the WTRUs 102g, 102h, 102i and the RAN 104c may be defined as an R1 reference point that implements the IEEE 802.16 specification. In addition, each of the WTRUs 102g, 102h, 102i may establish a logical interface (not shown) with the core network 106c. The logical interface between the WTRUs 102g, 102h, 102i and the core network 106c may be defined as an R2 reference point, which may be used for authentication, authorization, IP host configuration management, and/or mobility management.

The communication link between each of the base stations 140g, 140h, 140i may be defined as an R8 reference point that includes protocols for facilitating WTRU handovers and the transfer of data between base stations. The communication link between the base stations 140g, 140h, 140i and the ASN gateway 141 may be defined as an R6 reference point. The R6 reference point may include protocols for facilitating mobility management based on mobility events associated with each of the WTRUs 102g, 102h, 100i.

As shown in FIG. 1E, the RAN 104 may be connected to the core network 106c. The communication link between the RAN 104c and the core network 106c may defined as an R3 reference point that includes protocols for facilitating data transfer and mobility management capabilities, for example. The core network 106c may include a mobile IP home agent (MIP-HA) 144, an authentication, authorization, accounting (AAA) server 156, and a gateway 158. While each of the foregoing elements are depicted as part of the core network 106c, it will be appreciated that any one of these elements may be owned and/or operated by an entity other than the core network operator.

The MIP-HA may be responsible for IP address management, and may enable the WTRUs 102g, 102h, 102i to roam between different ASNs and/or different core networks. The MIP-HA 154 may provide the WTRUs 102g, 102h, 102i with access to packet-switched networks, such as the Internet 110, to facilitate communications between the WTRUs 102g, 102h, 102i and IP-enabled devices. The AAA server 156 may be responsible for user authentication and for supporting user services. The gateway 158 may facilitate interworking with other networks. For example, the gateway 158 may provide the WTRUs 102g, 102h, 102i with access to circuit-switched networks, such as the PSTN 108, to facilitate communications between the WTRUs 102g, 102h, 102i and traditional landline communications devices. In addition, the gateway 158 may provide the WTRUs 102g, 102h, 102i with access to the networks 112, which may include other wired or wireless networks that are owned and/or operated by other service providers.

Although not shown in FIG. 1E, it will be appreciated that the RAN 104c may be connected to other ASNs and the core network 106c may be connected to other core networks. The communication link between the RAN 104c the other ASNs may be defined as an R4 reference point, which may include protocols for coordinating the mobility of the WTRUs 102g, 102h, 102i between the RAN 104c and the other ASNs. The communication link between the core network 106c and the other core networks may be defined as an R5 reference, which may include protocols for facilitating interworking between home core networks and visited core networks.

According to an aspect, a method may be used to select a target HeNB for a handover. A connection may be established with a wireless transmit/receive unit (WTRU). The connection may be a session, wherein the session may comprise any of a selective IP traffic offload (SIPTO) or local IP access (LIPA) session. A target HeNB may be selected for the handover based on the ability of the target HeNB to support the session. For example, a determination may be made, based on CSG subscription information, that the WTRU is permitted to access the target HeNB. It may be verified that the target HeNB is connected to a local gateway (LGW) providing the session for the WTRU. It may also be determined that that the WTRU is permitted to receive service from the target HeNB. As another example, a target HeNB may be selected for the handover based on the ability of the target HeNB to support the session by receiving an indication that the session is supported on the target HeNB from the WTRU. As another example, an identity from the target HeNB that specifies a personal data network (PDN) or identifies a LGW may be used to select the target HeNB. Additionally, information may be received from the core network or an element thereof indicating that the target HeNB supports the session may be used to select the target HeNB.

The session may be handed over to the target HeNB. For example, a LGW transport layer address and a tunnel end point identification (TEID) may be determined. The LGW transport layer address and the TEID may be provided to the target HeNB to enable the target HeNB to continue the session.

According to another aspect, a WTRU may enable a LGW to distinguish between SIPTO and LIPA. An inter-access point name (APN) routing policy (IARP) that may provide a set of rules for routing UIP traffic across one or more active interfaces may be received, for example, from an access network discovery and selection function (ANDSF). A preferred APN may be determined using a prioritized list of APNs from the IARP. An IP interface may be selected to route an IP flow based on the preferred APN. The selected IP interface may be a dedicated packet network (PDN) connection. An indication may be transmitted to a network entity that the IP flow is SIPTO or LIPA. The network entity may be MME, a SGW, an LGW, a PGW, or the like. The indication, for example, may include IP address information to enable the LGW to identify the IP flow as SIPTO or LIPA. The indication may include an APN value to enable a LGW to identify the IP flow as SIPTO or LIPA. The IP flow may be transmitted using the selected IP interface.

According to another aspect, a method may be used to provide a handover. A HeNB may receive a handover indication. A determination may be made as to whether a connection to a WTRU may be established that may support a session; the session may comprise any of a SIPTO or LIPA session. An identity that specifies a personal data network (PDN) or identifies the LGW may be transmitted. Information may be transmitted to a core network and/or a WTRU to indicate that the HeNB may support the session. A LGW transport layer address and a tunnel endpoint identification (TEID) may be determined. A connection may be established with the WTRU. A session handover may be received.

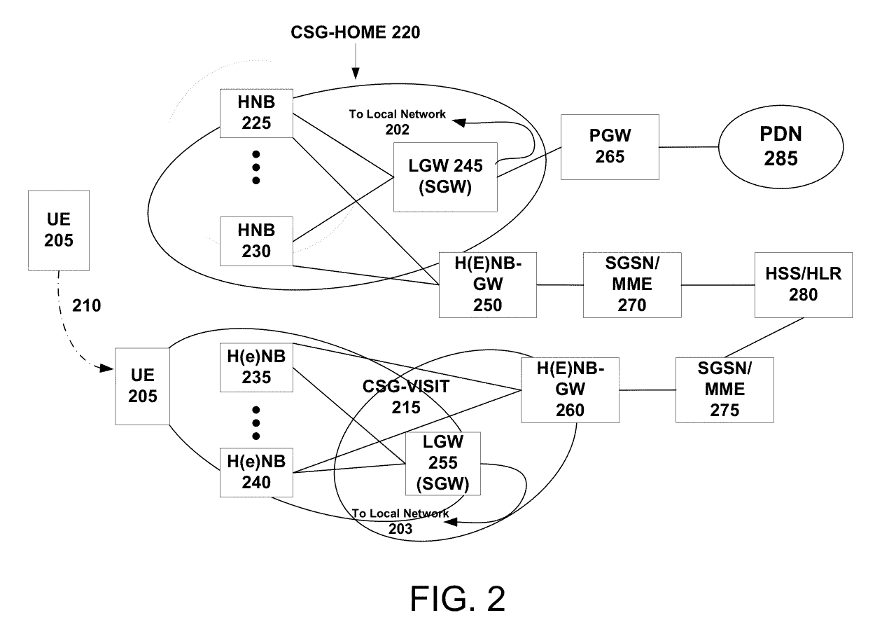

FIG. 2 depicts a block diagram of a communications network may provide Closed Subscriber Group (CSG) based Local IP Access (LIPA), Remote IP Access (RIPA), and/or Selective IP Traffic Offload (SIPTO). As shown in FIG. 2, UE 205 may communicate with CSG-Home 220 and may communicate with CSG-Visit at 215. This may be done, for example, to allow UE 205 to be handed over at 210 from CSG-Home 220 to CSG-215.

CSG-Home 220 may include one or more H(e)NB, such as HNB 225 and HNB 230. CSG-Home 220 may also include LGW 245, which may act as a SGW. LGW 245 may be operatively connected to local network 202, PGW 265, HNB 225 and HNB 230. PGW 265 may be operatively connected to PDN 285 and may allow CSG-Home 220 to communicate with PDN 285 via LGW 245. PDN 285 may not be part of CSG-Home 220.

H(e)NB-GW 250 may be operatively connected to HNB 225, HNB 240, and SGSN/MME 270. H(e)NB-GW 250 may be part of CSG-Home 220.

CSG-Visit 215 may include one or more H(e)NB, such as H(e)NB 235 and H(e)NB 240. CSG-Visit 215 may also include LGW 255, which may act as a SGW. LGW 255 may be operatively connected to local network 203, H(e)NB 235, and H(e)NB 240.

H(e)NB-GW 260 that may be operatively connected to H(e)NB 235, H(e)NB 240, and SGSN/MME 275. H(e)NB-GW 260 may be part of CSG-Visit 215.

HHS/HLR 280 may be operatively connected to SGN/MME 275 and SGNSN/MME 270. This may be done, for example, to allow CSG-Home 220 to communicate with CSG-Visit 215. For example, CSG-Home 220 many communicate with CSG-Visit 215 using HSS-HLR 280 to hand over UE 205 from CSG-Home 220 to CSG-Visit 215.

Activation or request of SIPTO and LIPA services may be provided. A subscriber may configure local IP access in his or her UE by simply choosing available networks supporting such service. Given the large number of features a UE may support, the subscriber may be able to select a network in a similar way as the subscriber known CSGs. This may be done, for example, to prevent the subscriber from having to get used to a new icon or menu.

A subscriber may also be allowed to choose a particular PDN Gateway (PGW), which may be the subscriber Local GW (LGW), regardless of whether or not the subscriber may be connected to his/her home network or a visited network. This may be done, for example, by choosing the same CSG or specific CSGs from a collection of CSGs that may guarantee the session the user is requesting will be setup towards a specific LGW.

The network may choose from a group of LGW associated to the CSG selected by the user. The selection of a LGW, triggered through the manual selection by the user of a CSG, may not need to rely on associating the CSG with a particular APN.

The UE may autonomously select activate/deactivate SIPTO/LIPA based on user setting or configuration of association between CSGs and the type of service or level of service desired to allow seamless mobility. For example, the user may manually blacklist the use of a SIPTO mechanism when connected to NB or H(e)NBs under the umbrella of a particular CSG. In addition, the user may manually configure the CSGs where SIPTO or LIPA may be provided. The network may attempt to provide SIPTO or LIPA services if the permission as selected by the user may be enabled for a particular CSG.

Service-specific selected IP traffic offload may be provided. A subscriber may use IP traffic offload points that suit the particular requirements of a service he/she requests.

In current systems, the granularity offered is on a per APN basis; however, this does not allow providing SIPTO specific differentiated service capabilities using the same APN. The UE may be able to provide the desired QoS for a specific connection through PDN CONNECTIVITY REQUEST messages. However, current networks will still use the APN stored in the subscriber record in the HSS to determine which PGW should be used to provide packet data connectivity.

Thus, the current solution restricts the selection to a particular APN, regardless of what services may be supported through the LGW connecting this APN. This restriction does not allow user configurable SIPTO/LIPA selection as means to guarantee the delivery of specific services, such as location awareness association and dynamic/on-the-fly or static billing regime. The selection of the LGW by the user does not necessarily mean that a user manually configures an IP addresses or any other addressing mechanism on a per service basis. The user may simply choose the service, and the service logic itself may trigger the selection of a suitable LGW/PGW by providing the required QoS that may guarantee the satisfactory delivery of the service.

Service-specific selected IP traffic offload and local IP access may be provided. In accordance with embodiments of the present disclosure, when a service requires a specific quality of service (QoS), the UE may specify which logical gateway (LGW) or packet data network gateway (PGW) may be chosen to provide this service. This may be a local gateway or a packet data network gateway deep in the operator's network. Thus, a UE may specify its choice in several ways as described herein. For example, the UE may specify a particular APN and CSG ID combination, thereby allowing separation of different levels of services provided by the same APN. In another example, the UE may specify a CSG ID only. In another example, the UE may specify a dummy APN, such as a Wildcard APN, and a required QoS, such as the QoS Class. The QoS class may be conversational, streaming, interactive and background. In another example, the UE may specify a CSG type (i.e., Hybrid or Closed). The CSG type may be defined to reflect a billing mode. The CSG type may also be defined to reflect QoS preferences. In another example, the UE may specify a wildcard CSG ID. For instance, based on the SLA agreement, a user in an unknown location, may configure its UE to perform SIPTO using any CSG that the user may be member of or that may match the wildcard CSG ID. The wild card CSGs may be associated with LGW or PGW with specific attributes (e.g., default QoS attribute). In yet another example, the UE may specify one or more of the aforementioned examples such as, for example, a UE at home may be configured to offload traffic based on specific CSG ID while in office the UE is configured to offload traffic based on CSG type or wildcard CSG. Moreover, several of the aforementioned examples may be used simultaneously, i.e., the SIPTO options may be configured separately for each application, or service. For example, a HeNB could be connected to multiple L-GWs, which could be associated with the same CSG or different CSG. SIPTO may then be performed with dynamic selection of the LGW from the pool of the LGWs. Depending on the user setting or expressed preference.

Subscriber-specific selected IP traffic and local IP access may be provided. A subscriber may select a particular LGW or PGW due to, for example, of advantages that may result from selecting a specific IP traffic offload point (e.g., a specific LGW or a specific PGW). This advantage may include being offered a better usage fee or special services including the possibility to access data services using his/her home operator provider data plan or the possibility to access to a corporate gateway or closed group gateway.

A CSG ID may be selected and used by the UE to signal the network to access a particular gateway on behalf of the subscriber. The CSG may be either a CSG ID broadcast by the network using current 3GPP procedures or a static CSG configured by the home operator to be displayed regardless of whether the subscriber is near the CSG that the UE may be displaying. In other words, the default CSG-Id may be the home CSG-Id for the HeNB/LGW pair at the home network or the first CSG-Id in the UE's whitelist. A UE may display a CSG-Id broadcast by a network, whether this is the home network or the visited network, and may include the CSG-Id broadcast by the subscriber Home (e)NB, along with other CSGs broadcast, even if the subscriber Home CSG-Id may not be part of the broadcast CSG-Ids.

The CSG may be used as a fully qualified domain name (FQDN) to determine the address of an LGW or a PGW. Thus, selecting a CSG for traffic offload purposes may trigger a service request procedure, which may include the selected CSG. For example, the PDN CONNECTIVITY REQUEST message may carry the CSG-Id where a relevant PGW, be it L-GW or any other PGW, resides. The membership verification procedure may also include a determination of a routable address towards an offload point using the selected CSG as a FQDN or a key to the relevant offload point IP address.

The CSG or CSG list may also be provided to the visited PLMN by the home PLMN upon registration (e.g., store in the HSS) or roaming. The visited PLMN may provide the UE with a list of available CSGs associated to specific PGW or LGW that may be selected, e.g., during the registration accept procedures. The UE may display CSG IDs contained in this list so that these CSG IDs may be manually selected to trigger PGW or LGW relocation. The selection procedure in the UE may allow a user to enter a specific CSG ID that may not be in the list that the VPLMN presented to the UE or user. The selection procedure may test the availability or reach-ability of the LGW or LGWs associated to the entered CSG-Id. This may be done using, for example, the VPLMN to HPLMN path. If the probe is successful, the tested CSG ID may be displayed next time.

Once the user selects a CSG, the CSG may be translated into a routable address. For example, the CSG may be a FQDN used by the servicing system to route traffic toward a specific PGW or LGW. In addition, the selection of an APN, combined with the other information such as CSG-Ids or QoS requirements may be used by the PCRF function to determine, through operator policies, the type of LGW or PGW that may be used to support a specific service request. When the currently selected PGW contacts the relevant PCRF, the PCRF may propose or suggest a new LGW or PGW through the IP connectivity access network (IP-CAN) Session Establishment Modification procedure. The current PGW may relay this information to the current SGW, through the Create Session Response message or any other message suited for this purpose. This may trigger LGW/PGW relocation.

Using some of the system and method embodiments described herein, the visited system may obtain from the subscriber HSS a list of CSG that the subscriber may be allowed to access. This may be done using, for example, subscriber profile information stored in the HSS. The list of CSG may include a CSG that may trigger the selection of a specific LGW or a PGW. For example, as shown in FIG. 2, UE 205 may be roaming in the vicinity of CSG-Visit 215, which may be a closed subscriber group identified by “CSG-VISIT.” The UE 205 may display both the “CSG-VISIT” name and the “CSG-HOME.” This may allow the subscriber to select the “CSG-HOME” CSG-Id that may indicate to the network that LGW 245 may be used.

As shown in FIG. 2, a LGW, such as LGW 245 or LGW 255, may provide both PGW and SGW capabilities to a subscriber accessing a particular section. A UE may move between HeNBs belonging to the same LGW or between an H(e)NB and a regular (e)NB. For example, UE 205 may move from HNB 225 to HNB 230, from H(e)NB 235 to H(e)NB 240, or may move between any H(e)NB or regular (e)NB belonging to the same LGW. A LGW may house both PGW and SGW functionality such that form the outset, if a UE accesses a particular CSG, the selection of the SGW may consider the CSG-ID, the requested AMBR, the provided LIP address or the like. For example, LGW 245 may house both PGW and SGW functionality. This may allow a UE 205 accesses or select a particular CSG, such as CSG-Home 220. The selection by UE 205 may lead to choosing a specific SGW that may connect to both a LGW and a PDG providing access to both local and public IP traffic offload. For example, when UE 205 selects CSG-Home 220, a SGW may connect LGW 245 and PGW 265 to provide access to PDN 285 and to local network 202.

The selection of the SGW at the MME may take into account whether or not SIPTO is allowed. The MME may also take into consideration the CSG ID or IDs provided by the user such that a common SGW may be chosen for both public and local traffic offload. The selected SGW may be the collocated LGW/SGW proposed herein. The selection of a common SGW may enable support for handover within user plane across HeNB connected to standalone LGWs/SGW without the need to relocate to a different SGW.

In another example embodiment, a user may provide information that may enable the simultaneous setup and configuration of both LIPA and/or SIPTO PGW/LGW/SGW resources. For example, a user may provide a collection of CSG-Ids associated to both LGW and PGW for both SIPTO and LIPA. This may enable the setup of multiple simultaneous connections towards these gateways, using as selection criteria, such as CSG IDs, QoS requirements provided by the UE, or the like. When two gateways, one local and one remote (or conventional) are set up using a common SGW, it may be possible to use the common SGW as NAT or IP translation point. Additionally, it may be possible facilitate IP preservation and hand over (HO).

A LGW/SGW combination as disclosed herein may support remote LIPA (RIPA). For example, when the UE moves out of the HeNB subsystem the user plane of the UE may remain anchored at the same SGW. For example, the UE may remain anchored at the SGW that may be collocated with the LGW). If the SGW is able to provide NAT functionality, the UE may not need to tear down its LIPA PDN connection when moving from HeNB to macro network. Additionally, the UE may be able to connect to the local network remotely. During the initial attach or for another PDN/PDP connection request, the MME may decide to select or relocate the SGW to the collocated LGW/SGW. For example, the MME may decide to select or relocate the SGW to the collocated LGW/SGW if the UE indicates that it wants to connect to the local network during an initial attach or PDN/PDP connection request.

In accordance with embodiments of the present disclosure, the MME, as part of the SGW selection function, may decide to use a LGW with SGW capabilities to set up the initial connection and may avoid SGW relocation

Seamless mobility may be supported. In order to support a seamless mobility, an autonomous CSG selection may take into account the user SIPTO/LIPA service preference based on the association between the CSGs and the L-GW/P-GW. The CSG white list may include additional entries such as SIPTO or LIPA support and user preference setting as defined herein above. Similarly, the proximity indication may be updated to provide information on user preferences in terms of SIPTO/LIPA offload points based on the association with LGWs or PGWs and user preference setting as defined herein above.

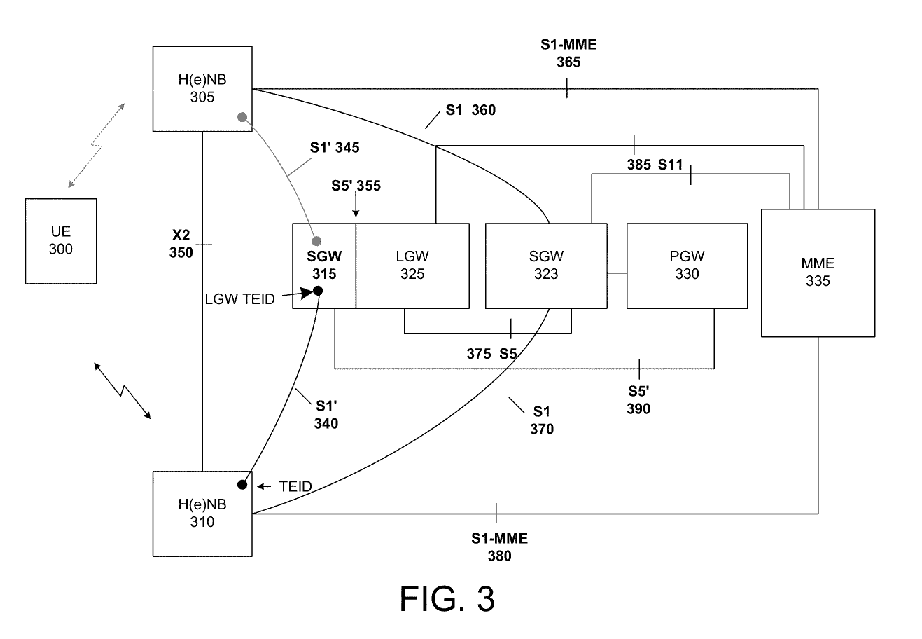

FIG. 3 depicts a block diagram of a communications network that may provide SIPTO and/or LIPA mobility in a Local Gateways (LGW) architecture. As shown in FIG. 3, UE 300 may communicate with one or more H(e)NB, such as H(e)NB 305 and H(e)NB 310. H(e)NB 305 and H(e)NB 310 may be operatively connected to each other. Additionally, H(e)NB 305 and/or H(e)NB 310 may be operatively connected to MME 335, SGW 323, LGW 320, and/or SGW 315. For example, MME 335 may communicate with H(e)NB 305 using an S1-MME interface at 365, and may communicate with H(e)NB 310 using an S1-MME interface at 380.

Described herein are architectural aspects for Local IP Access (LIPA) and Selective IP Traffic Offload (SIPTO) at a local network. Embodiments described herein may support mobility for LIPA between H(e)NBs located in a local network. For example, a standalone LGW may be used that is separate from the H(e)NB to which a UE is attached. Additionally, functionality may be described to support traffic offloading at the local network that may include mobility.

The introduction of mobility for LIPA and/or SIPTO in the local network as well as the architectural changes disclosed herein may allow a standalone LGW to impose modification in the procedures and/or concepts that may allow the connection of H(e)NB to the Core Network (CN).

In addition to a standalone LGW, capabilities may be included such as the ability to house a SGW within the LGW (i.e., a collocated LGW/SGW entity) and/or its impact on mobility procedures and/or EPS bearer establishment procedures. The introduction of a standalone LGW and/or mobility capabilities at the local network may also provide additional functionalities.

Systems, methods, and apparatus are described herein may allow for discovery of an H(e)NB by an LGW and/or discovery of an LGW by an H(e)NB. The introduction of a standalone LGW may impact the connection between the H(e)NB and LGW. For example, the LGW may not know the IP address of the H(e)NB, and/or H(e)NB may not know the IP address of the LGW.

Discovery may be possible by allowing the LGW and/or the H(e)NB to be preconfigured such that connections (e.g., Sxx or S1′) may be established through an operation and/or management procedure.

Discovery may also be possible by permitting a dynamic mechanism to be employed. For example, 3GPP concepts or IT-like concepts may be used, which may be outside of the scope of 3GPP specifications for example. 3GPP-based mechanisms commonly used for node selection purposes, e.g., PGW selection functions or MME selection functions, may be used for the mutual or independent discovery of standalone LGWs and/or H(e)NB nodes. These mechanisms may also be used for the dynamic establishment of a temporary connection between the two for the duration of the LIPA/SIPTO session, for example.

An H(e)NB may discover a standalone LGW. For example, an H(e)NB may dynamically discover an LGW when a UE may want to establish an EPS bearer. The UE may avail NAS procedures, such as Attach Request and/or PDP Connectivity Request for example, to trigger the discovery of a suitable LGW. When an INITIAL UE MESSAGE and/or an UPLINK NAS TRANSPORT message is received at the MME, the MME may use information within the UE profile stored in the HSS to resolve an LGW for the requesting UE. This procedure may relay on the provision of an APN, which may give the address of a particular PGW. Topological and/or geographical information may be provided to the HSS to determine a suitable address for a UE.

The Access Network Discovery and Selection Function (ANDSF) may be used to provide UEs with the address of an LGW according to the UE geographical and/or topological address. The UE may contact the ANDSF by using a mobile network operator core network (MNO CN) connection. The UE may also contact the ANDSF through a Non-3GPP access.

The H(e)NB may discover the LGW during the H(e)NB registration procedure. This may allow an H(e)NB to register to the H(e)NB GW. In this case, the LGW may or may not be co-located with the H(e)NB GW. The H(e)NB GW may also be provisioned with the LGW address. A registration response from the H(e)NB GW may include the LGW address to the H(e)NB.

LGW selection procedures may be provided. For example, LGW selection procedures may be provided at an initial system selection and/or at handover.

At initial system selection, the H(e)NB may select the LGW that may serve this connection from a pool of LGWs. The H(e)NB may request the core network to use the selected LGW. The LGW may be one of multiple LGWs to which the H(e)NB GW may be connected.

When the LGW is co-located with the H(e)NB GW, the H(e)NB GW may provide the LGW transport layer address (e.g., IP address) to the core network (e.g., MME, SGSN, etc.). For example, the H(e)NB GW may provide to the core network the LGW transport layer address if it is different from the H(e)NB GW transport layer address. The H(e)NB GW may relay to the H(e)NB the Tunnel Endpoint IDs (TEIDs) or correlation IDs of the E-RAB/RAB being established.

An APN may be mapped to an LGW and/or a set of LGWs. Similarly, an LGW may support several APNs. Under these scenarios, bearers (e.g., E-RABs, RABs) may be mapped on a real-time basis to SIPTO gateways and/or non-SIPTO gateways for example. The same, or similar, dynamic SIPTO traffic offload decisions may be performed where multiple LGWs for SIPTO traffic are under one or more PDN connections for example. When multiple LGWs for SIPTO traffic are under one PDN connection, the H(e)NB may select from the LGW pool based on the individual LGW load. The H(e)NB may schedule the LGW to report load status periodically or on one time report basis. The H(e)NB may also dynamically (e.g., bearer basis, GTP PDU basis, etc.) select the LGW from the pool of authorized LGWs or split the available traffic among the authorized LGW. The same, or similar, methods may be used when the multiple LGWs are allocated to the UE. Each subgroup of the LGWs may provide different IP addresses to the UE. There may be multiple SIPTO examples that may each be managed differently with a different level of QoS target base established during connection or based on the operator policy. The user may recommend the LGW or LGWs, and/or associated CSG, to use for example. In such case, multiple LGW transport layer addresses (e.g., IP addresses) may be provided by the H(e)NB to the core network, including the H(e)NB GW for example, or alternatively by the core network to the H(e)NB. A mapping between each LGW transport layer address and each E_RAB/RAB may be created and exchanged between the core network and the H(e)NB.

An LGW selection may be performed during handover. For example, LGW selection may be performed during handover by the target H(e)NB. Alternatively, the source H(e)NB may recommend or require that the target use a LGW. The LGW transport layer addresses and/or the uplink TEIDs may be transferred to the target H(e)NB, such as over an X2 message. For example, as shown in FIG. 3, H(e)NB 305 may transfer LGW transport layer address and/or the uplink TEIDs over an X2 message at 350.

When the handover is performed via the CN, the CN may provide an LGW transport later address to the target H(e)NB. Such information may be provided at the time of path switch for example. The methods described herein for Sxx (or S1′ for example) procedures (e.g., initial establishment) may also be used.

The LGW selection procedures performed at handover may be S1 interface procedures for example. In addition to the procedures described for initial session establishment, the following procedures may be defined over Sxx interface in support of mobility. For example, data bi-casting may be performed during handover/relocation. A patch switch procedure may be used as part of the handover execution. The target H(e)NB may exchange the DL TEID (for each bearer i.e., E-RAB/RAB for example) and/or its transport layer address with the LGW. The LGW may optionally provide in return the uplink TEIDs and/or its transport layer address. For example, referring to FIG. 3, H(e)NB 310 may exchange a DL TEID and/or its transport layer address with SWG 315 and/or LGW 320 via S1′ at 340. SWG 315 and/or LGW 320 may optionally provide an uplink TEIDs and/or a transport layer address to H(e)NB 310 via S1′ via 340.

The LGW selection procedures performed at handover may be X2 interface procedures. The X2 interface procedures may be intra-LGW procedures and/or inter-LGW procedures for example. FIG. 3 may illustrate one example of an intra-LGW handover procedure. With reference to FIG. 3, during an intra LGW handover procedure, when UE 300 moves from H(e)NB 305 to H(e)NB 310, X2 handover procedures may be used at 350. If a correlation ID is used instead of the regular SGW TEID, the target H(e)NB, such as H(e)NB 310, may provide the correlation ID to the SGW/LGW, such as SGW 315 and LGW 320, entity during the X2 HANDOVER REQUEST message.

If an inter-LGW handover is performed, the H(e)NB may provide enough information for the target H(e)NB to identify the serving GW and/or relevant details related to a User Plane path, such as the serving LGW address, the correlation id, and/or the SGW TEID for example. The target H(e)NB may use this information when it request a path through the X2 PATH SWITCH REQUEST message. The target H(e)NB may create a new session with the target LGW using target H(e)NB address and TEIDs for Sxx, and/or LGW S5 TEID. The source H(e)NB may also release Sxx user path with the source LGW by sending a Modify Bearer Request message.

As shown in FIG. 3, Sxx interface procedures, such as S1′, may be provided. For example, S1′ interface procedures may be provided at 340 and 345. The Sxx interface procedures may be in support of initial session establishment, bearer modification, and/or mobility, such as between H(e)NBs and/or between H(e)NBs and a macro network for example.

Tunnels between an H(e)NB and an LGW may be established, modified, released, and/or re-established, such as in the case of a handover for example. The CN may or may not be involved when the tunnels between H(e)NB and LGW are established, modified, released, and/or re-established. A UE may have simultaneous connection to the MNO CN and to an LIPA/SIPTO local network, it is described herein how an HO may be handled in such a situation. For example, messages may be exchanged and associated parameters may be defined. These procedures may work with or without an H(e)NB GW.

Described below are Sxx procedures, such as S1′ procedures, that may be used as shown in FIG. 3 at, for example, 340 and 345. Control plane signaling bearer may be created using an LGW transport layer address. The H(e)NB may establish an SCTP association toward the LGW with a predefined STCP destination port number. The H(e)NB may exchange a handshake message with the LGW to ensure both ends are ready to start signaling and/or perform a data packet exchange. There may be support for DL TEIDs transfer from H(e)NB to the LGW. In UTRAN for example, the LGW and the HNB may exchange IUP frame protocol control messages, including initialization messages and/or necessary parameters for example. Furthermore, the LGW may acquire the H(e)NB transport layer address. For the tunnel establishment/definition to be complete, the H(e)NB may know the LGW transport layer address and/or the TEID (uplink TEID). The H(e)NB transport layer address may be known to the LGW. This may be exchanged over the S1/Iu/Iurh interface or the Sxx interface for example.

Described below are S1 (Iu/Iurh) procedures that may be used as shown in FIG. 3 at, for example, 370 and 360 When the LGW is selected by the core network, the LGW transport layer address IE may be included in the E_RAB SETUP REQUEST or RAB ASSIGNMENT REQUEST. Multiple addresses may be provided from the CN. In the initial UE message, INITIAL Context setup response, UL NAS transport message, or any other equivalent message for example, the H(e)NB may provide the DL TEIDs towards the CN.

Described below are bearer modification procedures. The bearer modification procedures may be Sxx (e.g., S1′) specific and/or S1 (lu/lub) specific. For example, the bearer modification procedures may be used in FIG. 3 at 340, 345, and 370.

The Sxx procedure may support the bearer modification procedure between the LGW and the H(e)NB. The Sxx procedure may be used at 340 and 345. This may be in a form of bypassing SGW and/or MME (amid H(e)NB GW for example). Alternatively, the LGW may trigger bearer mediation procedure directly toward the H(e)NB and in parallel may send a notification to the Serving GW and/or the MME of such procedure. In support of such procedure, message such as bearer modification request/response or update bearer request/response may be exchange between the H(e)NB and the LGW.

The S1/Iu/Iub, may support the bearer modification procedures. For example, in addition to procedures described for the initial session establishment, the following procedures may be defined over Sxx interface in support of mobility. When an E-RAB/RAB is deleted and/or added, the MME may communicate the updated TEID for each E-RAB/RAB to the H(e)NB. Alternatively, the MME may indicate the newly deleted or added E-RAB/RAB TEID and/or correlation ID to the H(e)NB. Messages such as E-RAB MODIFY REQUEST/RESPONSE may be used to exchange information for example.

Access control procedures may be provided. The access control procedures may be intra-CSG or inter-CSG for example.

A broadcast of LIPA capability may be used to perform LIPA handover. In intra-CSG and/or inter-CSG, during mobility, the source H(e)NB may verify that the target H(e)NB supports LIPA and/or SIPTO. LIPA capability may be broadcast by the cell and/or reported to the source H(e)NB as part of the UE measurement for example. Such capability may also be exchanged between cells over an X2/Iur interface, such as at 350. The source H(e)NB, such as H(e)NB 305, may verify that the UE, such as UE 300, may be allowed to have LIPA/SIPTO service in the target H(e)NB, such as H(e)NB 310, as part of the membership information verification. The H(e)NB may also receive the information from the core network, such as during an initial context setup request message or relocation request message of a handover request message for example. Membership information with respect to multiple cells (e.g., source H(e)NB and neighboring H(e)NB) may be exchanged at a time between H(e)NB and the core network. Upon determination by the source H(e)NB that LIPA and/or SIPTO service may not be provided in the target H(e)NB, the source H(e)NB may take at least one of the following actions. For example, the source H(e)NB may deactivate LIPA and/or SIPTO, handover non-LIPA/SIPTO traffic while continuing to service LIPA/SIPTO bearer, abort the handover and select another H(e)NB which is LIPA/SIPTO capable, and/or abort the handover if intra-CSG LIPA/SIPTO capable mobility is supported.

Described below are various interactions between the interfaces described herein, such as the S1′, S1, X2, and/or S5 interfaces for example.

The embodiments described herein may impact the S1′, S1, X2, and/or S5 interface procedures. For example, the described embodiments may impact how the LGW selection is performed. There may be an impact on the S1 (Iu/Iuh interface) interface or X2 (Iur, Iurh) interface to enable session management and mobility management between the H(e)NB and the LGW for example.

There may be communication between LGW (or GGSN for example) and SGW (or SGSN for example) during the call establishment, during bearer modification, and/or during handover. There may be tunnel establishment between LGW (or GGSN for example) and SGW (or SGSN for example). If there is communication during the call establishment and/or tunnel establishment, there may be an impact on the S1 or X2 interfaces such that an H(e)NB may communicate and/or transfer data directly with the LGW once the session is established without going through the core network. According to one example, LGW uplink TEIDs/correlation IDs may be provided by the core network (e.g., MME and/or SGSN/MSC) to the H(e)NB. There may be other parameters provided to the H(e)NB from the CN. This information may be used in the context of a standalone LGW.

If there is no need for tunnel establishment between LGW (or GGSN for example) and SGW (or SGSN for example), there may be an impact on S1 or X2 interface such that H(e)NB may communicate and/or transfer data directly with the LGW once the session is established without going through the core network.

The communication contexts (e.g., TEIDs/correlation IDs, etc.) between the LGW and the SGW (or SGGSN for example) may be made aware to the H(e)NB. There may be interactions between the S1 and/or X2 interface and the Sxx (S1′ in FIG. 1) interface procedures for example.

S5 procedures may be provided. The S5 procedures may be used, for example, at 375 as shown in FIG. 3. The S5 procedures may include other procedures that are non-LGW selection related. The MME may be given the choice to either contact the LGW/SGW entity as if it were a regular SGW and/or obtained TEID information, or provide the existing correlation ID. The MME may make this decision based on whether a specific LGW address is given or a key is provided. This may allow the MME to select a LGW based on the characteristics of this key for example.

IP preservation procedures are also described herein. For example, an IP address may be preserved when a subscriber moves out of a local network, without the subscriber having uninterrupted services. The IP preservation may be ensured during mobility between a H(e)NB connected to different LGWs or during mobility between the H(e)NBs and the macro network.

According to one embodiment, a combined LGW/SGW entity may perform IP allocation for IP preservation. For example, the UE may be allocated a private IP address from a LGW/SGW entity. This may correspond to the LGW selected by the MME (e.g., based on the procedures described above). When this LGW/SGW entity receives messages from the UE, it may replace the private UE IP address with a routable IP Address, which may be similar to the functionality provided by a Network Address Translator (NAT). When the MME contacts the LGW/SGW entity, the LGW/SGW entity may provide the MME with a globally routable IP address. The MME may pass the routable IP address to a PGW as if it had been provided by the HSS. This may be done using a CREATE SESSION REQUEST message for example. The LGW/SGW entity may be able to allocate a public IP address as it may have both SGW and PGW capabilities.

With reference to FIG. 3, if SGW 315 is connected to PGW 330, through an S5′ interface at 390, both inbound and outbound handover procedures may be executed by anchoring the User Path at the LGW/SGW entity. For example, both inbound and outbound handover procedures may be executed by anchoring the User Path at SGW 315 and LGW 320 as SGW 315 may be connected to or part of LGW 320. LGW 325 may communicate with SGW 315 through an S5′ interface at 355 and may communicate with SGW 323 using an S5 interface at 375. SGW 323 may communicate with MME 335 using an S11 interface at 385.

In another embodiment, IP allocation may be performed through a PGW/LGW master-slave mechanism. For example, a master PGW and an LGW selection may be performed. The master LGW may control the IP allocation using the slave LGWs. An IP address allocation procedure may be defined and/or used between the LGW and the master PGW. During mobility between LGWs, the LGWs (or a designated entity in the core network PGW or MME for example) may take into account that the mobility may be intra-master PGW and/may not allocate another IP address. The IP address allocated by the initial LGW may be exchanged between LGWs, between a source and H(e)NBs, or between LGWs and H(e)NBs during the handover procedure.

During an initial attach procedure, a default EPS bearer may be established and an IP address may be allocated. In the allocation of the IP address, the UE may be provisioned with a static IP address. The static IP address may be derived from a LGW address for example. The UE may be allocated with an IP address dynamically allocated by the standalone LGW during the create session procedure.

Scenarios and architectures are described herein for when a standalone LGW interacts with other nodes, such as H(e)NB GW, Enterprise GW, and/or an ANDSF for example. For example, in an enterprise scenario, a LGW may register to a core network entity (e.g., MME). An enterprise GW may be deployed by a private host, rather than the operator. The LGW may register with the CN and authenticate itself.

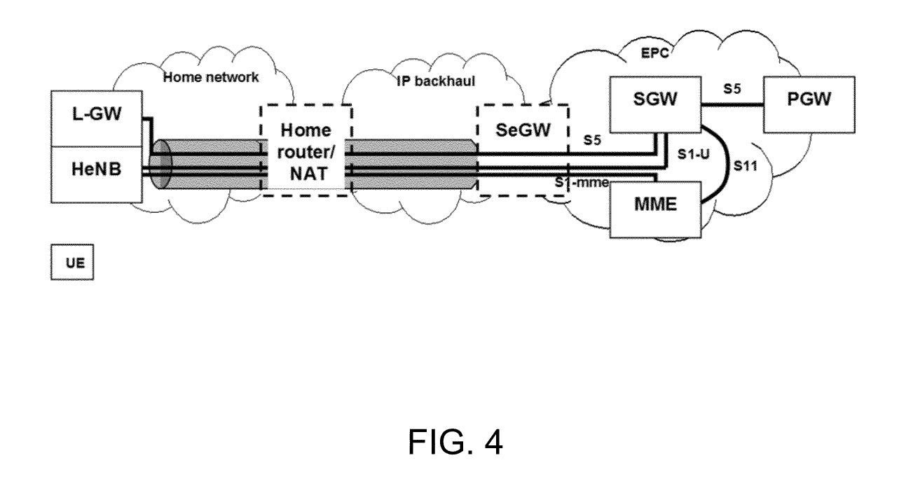

FIG. 4 depicts a block diagram of a communications network that may provide access to a local IP network through the use of a LGW. As shown in FIG. 4, a LIPA connection may be achieved by the use of a Local Gateway (LGW) having functions similar to a Packet Data Network Gateway PDN GW (or GGSN), where the LGW may be collocated on the HeNB. With the LGW collocated with a HeNB, when a UE moves out of the coverage of the HeNB (either in idle or connected mode), the LIPA connection may deactivate. When UE is in connected mode and is about to perform handover (HO) to another cell, the HeNB may inform the LGW about the HO so that the LGW may deactivate the LIPA PDN connection. This signaling may be done towards the MME. After the LIPA PDN connection is deactivated, the UE may be handed over to another cell. During the HO, if the MME sees that the LIPA bearer/PDN connection was not deactivated, then the MME may reject the HO.

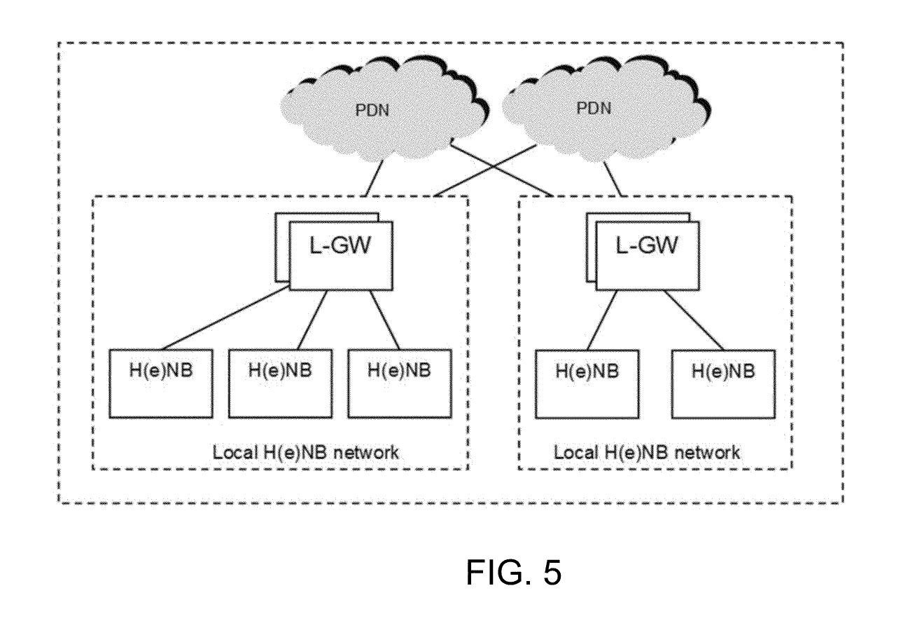

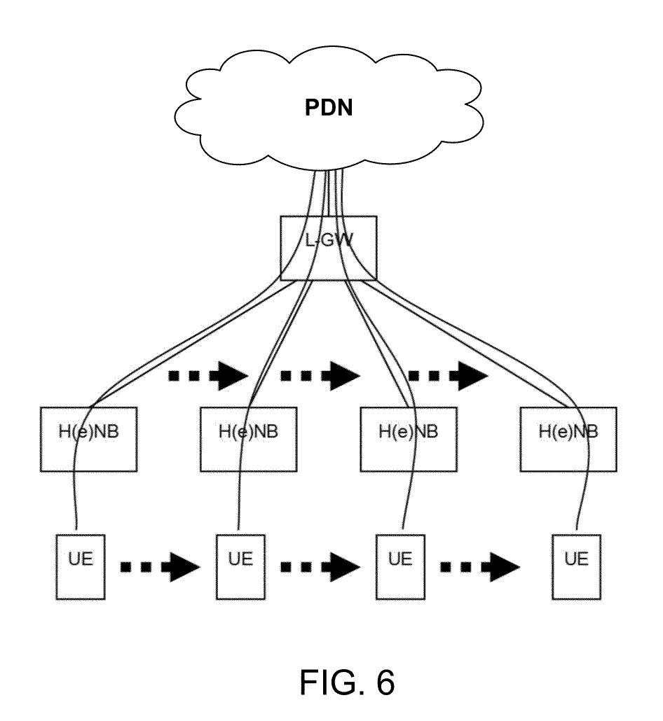

FIG. 5 depicts a block diagram of a communications network where a LGW may be collocated with an H(e)NB. FIG. 6 depicts a block diagram of a communications network where user equipment (UE) may maintain a connection to a LGW while being handed off to an H(e)NB. A standalone LGW may be used to allow continuity of a LIPA PDN connection as a UE moves between HeNBs. A standalone LGW may be a LGW that may not be collocated on a HeNB. This may be done, for example, to allow the LGW to be used by multiple HeNBs that may connect to the same LGW. A UE with a LIPA PDN connection may move across these HeNBs, which may be referred to as a HeNB subsystem, while maintaining its LIPA PDN connection. If a UE moves out of the HeNB subsystem altogether, such as when the UE moves out of coverage of all the HeNBs that connect to a LGW, then the UE's PDN connection for LIPA may be deactivated.

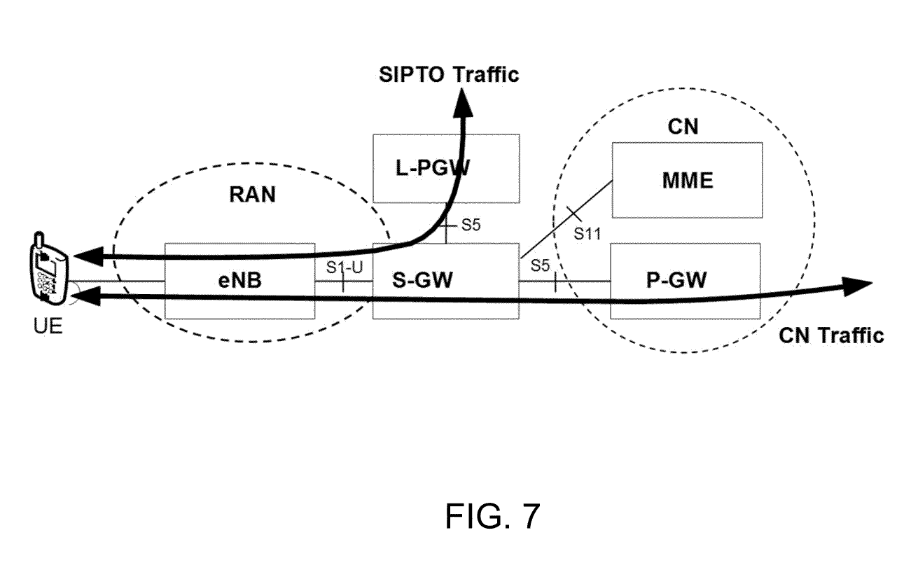

FIG. 7 depicts a block diagram of a communications network where a network operator may choose a public data network (PDN) gateway (GW) to offload traffic. A shown in FIG. 7, SIPTO (Selected IP Traffic Offload) may occur when a network operator chooses a PDN GW that may be used to offload traffic to the Internet. This may be done, for example, to allow a PDN GW different from the core network's (CN) PDN GW to be used when a physical location or IP topological location of the UE makes it favorable to do so. SIPTO may occur regardless of whether the radio connection of a UE may be obtained via an eNB or a HeNB. The selection of another PDN GW may not be known to the UE, and the offload of the UE's traffic to a L-PGW may degrade the user's service experience. The offload of user data to the Internet may be made via a LGW that is on the HeNB subsystem as shown below.

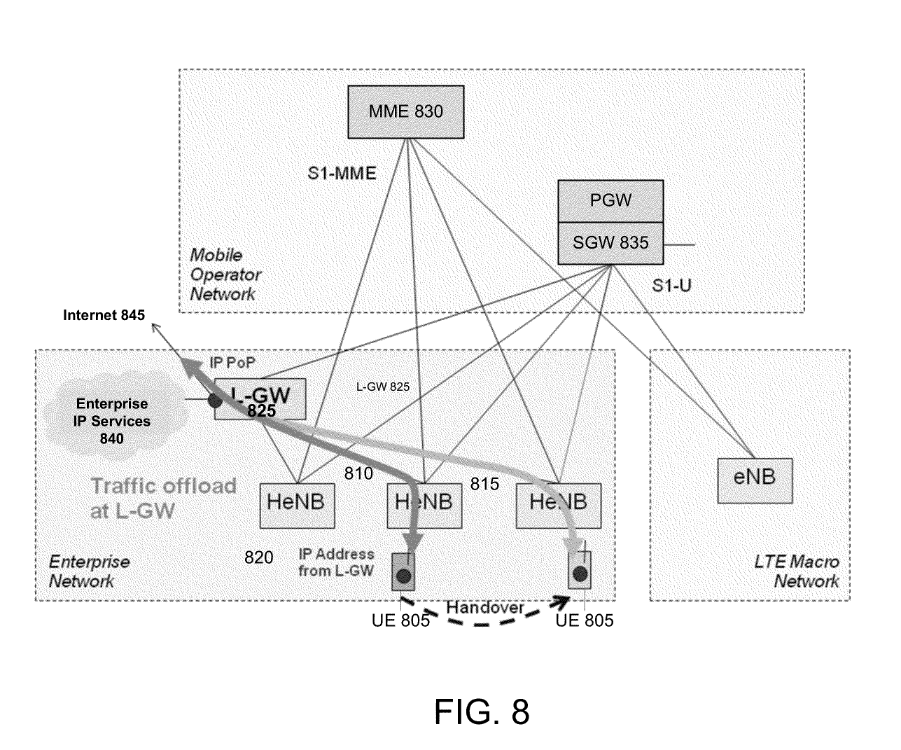

FIG. 8 depicts a block diagram of a communications network that may offload user data using a LGW. According to another embodiment, SIPTO and LIPA traffic may be differentiated at an H(e)NB subsystem, such as a LGW. As illustrated in FIG. 8, both SIPTO and LIPA may be provided in an H(e)NB subsystem. At 820, UE 805 may have a local connection to local enterprise IP services 845 and may have a non-local connection to Internet 845, which may be enabled by offloading traffic from LGW 825. LGW 825 may differentiate local traffic from Internet traffic. LGW 820 may also address issues that may arise when one PDN connection may be used for both LIPA and Internet traffic (i.e. SIPTO).

Described below are various methods for differentiating SIPTO from LIPA traffic at a LGW, such as LGW 825. These methods may be used in any combination and in any system. Moreover, examples below are given using MME/SGW, such as MME 830 and SGW 835, and they may apply to an SGSN or other nodes in a communication system, such as an RNC or H(e)NB GW for example.

LGW 825 may use a PDN connection for differentiating SIPTO from LIPA traffic. A UE, such as UE 805, may use dedicated PDN connections for LIPA and/or SIPTO. The use of a dedicated PDN connection together with an APN value may allow the LGW to differentiate SIPTO from LIPA traffic. For example, LGW 825 may differentiate SIPTO from LIPA traffic using a dedicated PDN connection used by UE 805 and an APN value. If UE 805 does not include an APN value, or if UE 805 does not have the information for an APN value that leads to SIPTO or LIPA, then MME 830 and/or SGW 835 may inform LGW 825 that a PDN connection is being established for either LIPA or SIPTO. This may be done in the Create Session Request that may be sent from SGW 835 to the LGW 825 for example. This may be triggered by an indication in the Create Session Request that may be sent from MME 830 to SGW 835. If MME 830 knows that a PDN that is to be set up is for LIPA or SIPTO, MME 830 may provide this indication to SGW 835. SGW 835 may provide the indication to LGW 825. Traffic arriving to the LGW 825 may be known to belong to either SIPTO or LIPA. MME 830 may provide this information to LGW 825 via signaling between both entities.

LGW 825 may identify traffic as LIPA or SIPTO based on the IP addressing information. For example, if the destination IP address is that of a local destination (e.g., a private IP address), then LGW 825 may process this traffic as an LIPA traffic and may route the traffic to the local network. Alternatively, if the destination IP address is an address of a node in the Internet (e.g. a public IP address) then the LGW may route the related IP packets to the Internet (i.e. the traffic is SIPTO). For example, LGW 825 may route the related IP packets to Internet 845.

UE 805 may indicate to MME 830, SGW 835, and/or LGW 825 that a flow of IP traffic may be LIPA or SIPTO. This may be done by modifying established bearers to install packet filters such that the traffic is LIPA or SIPTO for example. For example, the packet filters may make an indication, based on the type of IP addresses, that certain flow of IP is LIPA or SIPTO. The indication for LIPA or SIPTO may be part of any NAS session management message. For example, the Protocol Configuration Options IE may include information about whether a specific flow is LIPA or SIPTO. UE 805 may provide this information in each NAS session management signaling message for example. UE 805 may obtain this information, such as by information exchange with an upper layer (e.g., application layer) which may provide information about the destination IP address for example. The information about the destination IP address may indicate whether the destination address is private or public for example. UE 805 may use certain policies from ANDSF to know whether it may indicate certain flows to be LIPA or SIPTO traffic. This may be based on operator policies such as expected QoS, type of application, characteristic of application, or the like. For example, UE 806 may use real versus non-real time traffic. The indication from UE 805 may be forwarded to LGW 825 by MME 830 and/or SGW 835 so that an IP flow may be identified as LIPA or SIPTO.

UE 805 may use a different bearer for different services. For example, UE 805 may use a dedicated bearer for LIPA traffic and a different dedicated bearer for SIPTO traffic. UE 805 may use different dedicated bearers even if LIPA and SPITO traffic require the same QoS level. Upon establishment of a bearer, UE 805 may provide an indication in the NAS session management messages (e.g., EPS Bearer Resource Allocation Request or EPS Bearer Modification Request message) that may indicate that the bearer being established or modified may be for LIPA or SIPTO traffic. The indication may be based on an interaction or may be based on received information from the application layers (e.g., specific application or an application may indicate that the bearer or IP flow is being established for LIPA or SIPTO traffic). The MME 830 or SGW 835 may forward this to LGW 825 in messages that may be exchanged between these nodes, such as Modify Bearer Request message. With this indication, LGW 825 may route the IP flows or bearers either locally (i.e. LIPA traffic) or to the Internet (i.e. SIPTO traffic).

As described above, FIG. 8 depicts a block diagram of a communications network that may offload user data using a LGW. The communications network may permit LIPA and SIPO. The LGW may be used to access a local IP network (LIPA) and may be used to offload a data from a UE to the Internet via the same LGW.

The following description relates to LIPA mobility and SIPTO service continuity. For example, the following description discusses methods and systems for achieving LIPA mobility and SIPTO service continuity.

For a UE with a LIPA PDN connection, if a handover is to occur to a target HeNB, a source HeNB may choose a target HeNB that may connect to the same LGW where the LIPA PDN connection may be setup. Moreover, the UE may have CSG access subscription that may allow the UE to access the target HeNB from a radio perspective. This may be based on the CSG ID that may be broadcast by the target cell. This may also be based on the IDs of potential CSGs (HeNBs) that the UE may be allowed to camp on as per the Operator CSG List (OCL) or Allowed CSG List (ACL). Thus, a source may need to determine if the UE may be allowed on the target HeNB, and may need to determine the target cell that may connect to the same LGW that may provide LIPA PDN connection. This may also be applicable to SIPTO.

If the UE may be allowed to access the target HeNB and there may be a connection from that HeNB to the LGW, the UE, from a service perspective, may not be allowed to access LIPA service from that HeNB (CSG). This may be defined by operator policies or subscription information of the UE. Such information may be available to the MME and this node may not allow certain HOs to occur if LIPA mobility/SIPTO service continuity may not Occur.

Rules may be established such that a HO within the HeNB subsystem may have to guarantee LIPA mobility/SIPTO service continuity. A target HeNB may connect to a LGW and a UE may have access to the CSG and LIPA from that cell. However, the target HeNB may not admit certain bearers due to load conditions. If the bearers that are not admitted are LIPA bearers, then the HO may proceed or may be canceled.

The target HeNB may differentiate between LIPA traffic and non-LIPA traffic. This may occur, for example, if the non-LIPA traffic was provided via the CN. If the target HeNB cannot admit the LIPA bearers, then it may need to know which bearers pertain to the LIPA PDN connection. These bearers may not be maintained at the target.

The MME may reject a HO if it sees that the LIPA PDN connection may not have been released prior to the HO initiation. The MME may be able to differentiate between an R10 and R11 LIPA mobility scenarios such that may not reject HO for LIPA session in an R11 scenario.

LIPA/SIPTO user plane and resources may be handled during HO. For example, after HO to a target cell from where LIPA service may be maintained, there may be a need to switch the data path from the LGW to the target HeNB. Moreover, during HO, the LGW may still be receiving DL packets (LIPA or SIPTO related packets). The LGW, the source HeNB, or both the LGW and the source HeNB may perform buffering. After the HO, a node may initiate the release of resources between the LGW and the source HeNB.

For connected mode mobility out of the HeNB subsystem, downlink (DL) packets from the LGW (LIPA or SIPTO) may be handled while a HO is ongoing. For example, a node, such as the LGW, may buffer these packets. The packets may be forwarded to the target HeNB.

A TEID (tunnel endpoint ID) may be used between the LGW and a HeNB. The TEID may provide a direct path between the two nodes (i.e. for LIPA/SIPTO@LGW traffic).

There may multiple LGWs and HeNBs. If a UE is paged while in idle mode, the UE may respond to paging from a HeNB. The HeNB may not be not connected to the LGW that the UE may have a LIPA PDN connection. The HeNB may also not be connected to the LGW that the UE may be using to offload traffic. It may be that the user may not want to accept any LIPA/SIPTO@LGW traffics/session.

In Rel-10 deployment for LIPA, a LIPA PDN connection will not be handed over due to lack of LIPA mobility. At the handover in Rel-10, the source MME checks whether the LIPA PDN connection has been released. If it has not been released and the handover is the S1-based handover or the Inter-RAT handover, the source MME shall reject the handover. If the LIPA PDN connection has not been released and the handover is a X2-based handover, the MME shall send a Path Switch Request Failure message to the target HeNB. The MME performs explicit detach of the UE as described in the MME initiated detach procedure.

In Rel-10, the MME always reject a HO if it detects that the LIPA PDN connection/bearers have not been released. However, the UE may have two PDN connections, one for LIPA, and another for non-LIPA sessions. Thus, rejecting a HO would imply possible release of the UE's RRC connection, especially for X2 based HO. In this case, the non-LIPA sessions and the user experience may be impacted negative way.

The embodiments may ensure LIPA and/or SIPTO mobility. A source HeNB may use rules whenever there is LIPA or SIPTO session. These rules may be configured in the HeNB or may be provided either by the MME or via O&M procedures. The rules may also be driven by the user subscription. For example, some users may have subscriptions that may guarantee LIPA mobility for any target HeNB within the HeNB subsystem; other users may be allowed to access LIPA services from selected HeNBs within the HeNB subsystem. In embodiments, a HeNB may guarantee LIPA and/or mobility within the HeNB subsystem, may guarantee LIPA mobility only, may guarantee SIPTO mobility only, or any combination thereof. If a target HeNB connects to the LGW and the UE may be allowed to access the HeNB, a HeNB may prioritize (i.e. admit) SIPTO bearers first, may prioritize (i.e. admit) LIPA bearers first, or may determine the priority of either SIPTO or LIPA bearers based on user consent or based on subscription information.

The rules may be enforced by the source HeNB, the target HeNB, or the MME. If provided by the MME, the provisioning may be done via any S1-AP message. Moreover, if already available in the source HeNB, the rules may be provided to the target during the HO in order for the target to know how to handle any subsequent HO.

For LIPA mobility to take place, there may be conditions that need to be met. For example, the UE may need to be allowed to access the target HeNB (based on CSG subscription information). The target HeNB may need to connect to the same LGW that provides the LIPA PDN connection for the UE in questions. The UE may need to be allowed to get LIPA services from the target HeNB. The conditions may be checked at the source HeNB, the target HeNB, the MME, or the LGW. The MME may provide information, such as information related to the identified conditions, to the source HeNB, the LGW, and the target HeNB. The LGW may also provide such information to the source/target HeNB in place of or in combination with the MME.

The provisioning of such information may be done for UEs that may be allowed on the system. This may occur even if some of these UEs may not yet be registered. Alternatively, such information may be provided form one node to another when a PDN connection is established, or when the UE moves in or out of the HeNB subsystem.

Conditions and service rules may be enforced by a source HeNB. The source HeNB may use available information to choose a target CSG such certain conditions may be met. For example, the source HENB may choose a target CSG such that a UE may have access to target HeNB, a target HeNB may to connect to the same LGW that provides the LIPA PDN connection for the UE, and the UE may be allowed to get LIPA services from the target HeNB. Alternatively, the source HeNB may probe the MME or LGW, upon a trigger for HO, to get such information. Thus, the source HeNB may choose a target HeNB that may guarantee LIPA and/or SIPTO service continuity. The source HeNB may also take into account the service rules when choosing a target HeNB. In addition, the source HeNB may request measurements from the UE on a specific HeNB to make sure that the radio conditions may be good enough to continue the LIPA or SIPTO service. The UE or the network may apply a bias to measurements in order to favor HOs to target HeNBs that may provide LIPA and/or SIPTO service continuity. Thus, the source HeNB may, before handing a UE over to another HeNB, take into account the UE may be allowed to access the target CSG, the target HeNB may connect to the LGW with which LIPA PDN connection is established, and the UE may be allowed to get LIPA services from the target HeNB. The source may also take into account, or verify that a subset of these conditions based on network operator policies. The source HeNB may choose HeNB cells for which all or a subset of these conditions are met. Alternatively, if the UE's radio condition is such that HO may be necessary, the source HeNB may ignore all or a subset of these conditions. Furthermore, the source HeNB may decide to perform the HO of non-LIPA bearers regardless of the service rules defined above. For example, a service rule may be defined to achieve LIPA mobility as much as possible, but it may not be required. The source HeNB may probe the LGW or the MME to find out about the subset of conditions or rules that need to be verified upon HO initiation.

Depending on the service rules, the source HeNB may probe the MME or individual potential target HeNBs to request information regarding certain conditions. For example, the target HeNB may be probed to find out if it connects to a specific LGW. The target HeNB may provide information about the LGWs it connects to even if connection to a specific LGW was requested. Such information may also be provided between the HeNBs during HO. This may occur via a MME. For example, even if a target HeNB rejects bearers that may be LIPA/SIPTO@LGW, the target may still provide information about the LGWs to which it connects, together with addressing information of these LGWs, or any other information related to LIPA/SIPTO@LGW.

If the source knows that a potential target HeNB may not be used to maintain LIPA/SIPTO@LGW service continuity for any reason, the source HeNB may initiate the HO without including the LIPA/SIPTO@LGW bearers. Unlike R10, in an embodiment the source HeNB may not need to wait for the release of the LIPA/SIPTO@LGW bearers/PDN connection before proceeding with the HO. For example, the HeNB may not wait for the release if there is an existing IMS emergency call for the UE. The resources (bearers/PDN connection) may be released after the HO by either the MME/SGW, or source HeNB. Resource releases are further described herein.

If there is an existing IMS emergency call, or any emergency VoIP call for the UE, the source/target HeNB or MME/SGW may not handover any LIPA/SIPTO@LGW bearers regardless of any service rule. This may be done, for example, to avoid delays to the HO and potential drop of the emergency call.

Conditions and service rules may be enforced by a Target HeNB. The source HeNB may not check for any condition and may select the best target HeNB based on measurement reports from the UE. For example, the source HeNB may select a target HeNB based on current HO procedures or some form of biased measurement. The source HeNB may check for a subset of the conditions and may leave the other conditions to be enforced or verified by the target HeNB. For example, the source HeNB may perform a CSG access check or determine whether the target may connect to the LGW. Using any available information, or by probing the MME after receiving the HO request, the target HeNB may check whether or not the LIPA bearers may be transferred upon HO. The target HeNB may check for all conditions, such as those described previously, or a subset of them even the source HeNB may have already performed a check on any of these conditions. The target HeNB may probe the source HeNB, LGW or the MME to find out about the subset of conditions or rules that may need to be verified upon HO initiation.

Conditions and services rules may be enforced by the MME. For example, the MME may choose a target CSG such that a UE may have access to target HeNB, a target HeNB may to connect to the same LGW that provides the LIPA PDN connection for the UE, and the UE may be allowed to get LIPA services from the target HeNB. The may MME enforce all or a subset of the conditions. The embodiments described with respect to the target or source HeNB may also apply to the MME. The MME may reject a HO request (as per S1 HO) or path switch request (as per X2 HO) based on the conditions and service rules. The MME may get this information from the HSS upon registration or upon establishment of a PDN connection for LIPA or SIPTO at the LGW. The LGW may enforce these rules any of the nodes. For example, the source HeNB, the target HeNB, or the MME may probe the LGW to get the service rules and conditions.

For certain HO scenarios or service rules, the MME may modify the HO messages to meet the required rule or subscription for a given UE or user. For example, if the rule or subscription is such that the user may not allowed to receive LIPA/SIPTO@LGW from a given chosen target HeNB, the MME may modify the HO message (e.g. on SLAP) to remove the LIPA bearers from the requested bearers to be admitted. Thus, the target HeNB may not be aware of the fact that they actually included by the source. The MME may also modify the response from the target to include a cause code that may indicate that the MME may have modified the message. The cause code may also indicate the reason why the LIPA/SIPTO@LGW bearers may not have been included or admitted in the target. The MME may inform the target about the modification and the target may then include an appropriate cause code as explained.

The source and/or target HeNB may download information related to the conditions or service rules from the HMS system at the startup. The LGW(s) that source and/or target they may connect to may be included in the information. Several methods may be used to enable the exchange of this information between H(e)NB. The H(e)NBs may exchange this information during an X2 setup procedure, an ENB configuration update procedure, or an Iurh-like procedure. The H(e)NBs may register to the LGW and then may get the list of other HeNB connected to the same LGW through the registration procedure, such as registration request or response. The H(e)NBs may exchange the information using procedures such as configuration transfer procedure between the LGW and the H(e)NB once a neighbor H(e)NB is discovered.

The HeNBs may broadcast an identity that may specify the PDN to which the LGW connects or may identify the LGW itself. Every HeNB may broadcast such an ID if it is connected to at least one LGW. Moreover, if the HeNB connects to several LGWs, then the IDs of each of these LGWs may be broadcasted. The UE may report the LGW, or PDN, IDs that may be broadcast by neighboring HeNBs. This may be done, for example, to determine a target HeNB that may connect to a given LGW of interest. The UE may report the LGW, or PDN, IDS in the measurement reports provided by the UE or in a standalone RRC message. If the UE reports any such ID, the source HeNB may use this ID to decide on potential HO that may provide LIPA/SIPTO service continuity. Alternatively, the UE may indicate to the source HeNB that the target, based on broadcast information, may be connected to the at least one LGW that is the same. This may be achieved by the UE comparing the LGW IDs broadcast at the source and the target. Thus, the UE may provide this indication via a 1-bit position where, for example, a value of 1 may indicate that the target HeNB connects to the same LGW as that broadcast by the source, and a value of 0 may indicate that the target may not connect to the LGW in question. Two-bit information element may be used. For example, a value of 1 may indicate that the target H(e)NB may connect to the same LGW broadcast by the source, value of 2 may indicate that the target H(e)NB connects to a different LGW as that broadcast by the source, and a value of 0 may indicate no connection to any target LGW.

Any subset of information related to the identified conditions or service rules may be provided to the source or target HeNB via ANDSF. This method may also be used to provide such information to the UE that may relay the information to a source HeNB, a target HeNB, MME, or the like. This may occur via RRC or NAS messages. The UE may forward this information to the HeNB before the handover or during the handover process.

For the embodiments described above, if a node rejects a HO, then a cause code may be included to indicate the reason for HO rejection. For example, a cause code may indicate why a target HeNB may not connect to the LGW. As another example, the cause code may indicate why a UE may not be allowed, from service perspective, to access the LGW from the target HeNB even if both nodes are connected. The cause code may be in any S1 or X2 related HO messages that may be exchanged between the target and source HeNBs, the target HeNB and MME, or the MME and the source HeNB.

Even though LIPA bearers or LIPA PDN connections may not be allowed in a target cell, a handover procedure may not be rejected by a node that is processing the HO, for example, when there is at least one more additional non-LIPA PDN connection. For example, during a S1/X2 handover procedure, if the target MME detects that LIPA mobility may not be allowed and that the LIPA bearers may not been released during the HO, the MME may still accept the HO procedure but may only admit the non-LIPA bearers. Moreover, the MME may inform the source/target cell that the non-LIPA bearers may have been admitted. The target cell may also inform the source that the LIPA bearers may have been released. The target may also include a cause code that it may have received from the CN about why the bearers have been released. The target cell may do so using the UE Context Release message (X2 message) or any equivalent message that may be defined (or existing) for S1/X2 HO procedure. The target cell may include a list of bearers that may not have been admitted at the target. Thus, the source may use this indication (bearers that were released and/or cause code) to release the resources with the LGW, for example, by comparing the bearers that were not admitted to the LIPA bearer identity at the source. In addition, the MME may release the LIPA PDN connection towards the UE and the LGW or the source cell that connected to the LGW. In turn, the LGW may then release its connection/resources with the LGW.

For example, given a UE with a LIPA PDN connection and at least an additional non-LIPA PDN connection, if an MME receives a Path Switch Request message from a target cell, during X2 HO procedure for the UE in question, the MME may verify if LIPA bearers have been released. If not, the MME may accept the HO but may indicate to the target cell, in a Path Switch Request Acknowledge message, that the LIPA bearers may not be allowed or admitted. For example, the MME may deactivate these bearers and may include these bearers in the E-RAB to be Released IE, which may inform that these bearers may not be admitted by the target cell. In addition, the MME may inform the LGW and/or the source cell that the LIPA PDN connection may be released. These nodes may then release the resources that were used for the LIPA PDN connection. As explained earlier, the target cell may also inform the source cell about the deactivation of certain bearers, such as the LIPA bearers. Upon reception of such an indication, the source cell may then release the resources with the LGW. Even the embodiments may have been explained using an MME, the same actions may be done by the other nodes e.g. target cell, LGW, or the like.

The target HeNB may be informed about LIPA or SIPTO bearers. The source HeNB (or the MME) may provide an indication to a (potential) target HeNB about which of the bearers may be established with the LGW. The indication may be on a high level where a subset (or all) of the available bearers may be tagged to be established with the LGW. For example, there may be a direct path from the HeNB to the LGW. Alternatively, the indication may be on a thinner granularity where each bearer may be tagged to be LIPA, SIPTO, non-LIPA or non-SIPTO traffic. Not tagging any bearer may be interpreted by the target HeNB as bearers that may be forwarded on the S1-U interface towards the Serving Gateway (SGW).

The tagging of such bearers may be done in several ways. For example, a bitmap may be defined for all active bearers where a value of 1 may indicate that the bearer is handled towards the LGW, such as a LIPA or SIPTO bearer towards LGW. A value of 0 may mean that the bearer may be handled towards the SGW. For example, there may not be a direct path for the corresponding bearer toward the LGW. Such a bitmap may also be defined for LIPA and SIPTO, or individually for LIPA or SIPTO. Alternatively, every bearer may have its own bitmap to identify it as LIPA, SIPTO, or CN bearer.

The target may take this indication (identification or tagging) into account when admitting certain bearers. For example, if the target HeNB does not connect to the LGW of interest, the target HeNB may use the identification proposed herein to not admit IPA/SIPTO@LGW bearers.

Alternatively, if the radio load of the HeNB is such that only a subset of these bearers may be admitted, the target HeNB may use the identification proposed above to admit LIPA/SIPTO bearers but not CN bearers. This may occur, for example, based on service rules that may guarantee LIPA/SIPTO service continuity.

The embodiments above apply to S1 or X2 handovers (or any equivalent HO signaling/procedure in UTRAN).

The identification or tagging may also be performed by the MME in case of S1 HO. The MME may include this information in the HO request message (S1AP) that it forwards to the target cell. The target may also keep this tagging for any bearer that may be admitted or released. Thus, the MME or source HeNB may continue or abort the HO based on the admitted bearers e.g. if the service rules are not met for this UE.

In the case of intra-LGW handover the correlation ID received during the PDN connection setup may be passed on to the target in the handover request message or any other equivalent message for each LIPA bearer. The Target HNB may make the determination of whether the bearer is a LIPA bearer or a non-LIPA bearer based on the presence of an associated correlation ID in the handover request message. In the case of inter-LGW handover, the correlation ID may also be used to differentiate LIPA bearer from non-LIPA bearer. The correlation ID may have a meaning in terms of correlating the direct path H(e)NB<->LGW bearers to the indirect path via the SGW.

It may also be useful that the LGW differentiate LIPA from SIPTO traffic. The LIPA bearers and SIPTO bearers may be assigned TEIDs from distinct ranges of TEID ranges. The LIPA bearers and SIPTO bearers TEIDs may be assigned distinct registered destination TEID values. For example, LIPA bearers TEIDs may use a registered destination TEID while SIPTO bearers may use another specific registered destination TEID. Two different correlation IDs may be defined, one for the mapping of LIPA bearer and the other for the mapping of SIPTO bearer.

The MME may be informed about LGW deployment during HO. The source HeNB (in case of S1 HO) or target HeNB (in case of X2 HO) may inform the MME that a HO, for a given UE with LIPA PDN connection, may be following a R11 deployment/HO scenario. For example, this HO may be for a scenario/deployment with a standalone LGW. Thus, with this indication, the MME may differentiate R10 vs R11 LIPA mobility scenarios such that R11 LIPA HOs may not be rejected as may be the case for R10.

The indication may be an explicit indication, such as adding a new IE in the HO message. Alternatively, the MME may use any additional information that may not be included in R10 to conclude that this LIPA mobility may be for a R11 deployment scenario. An example of such information may include the LGW address that may be included in the HO messages (S1 or X2, e.g. HO Request or Path Switch Request).

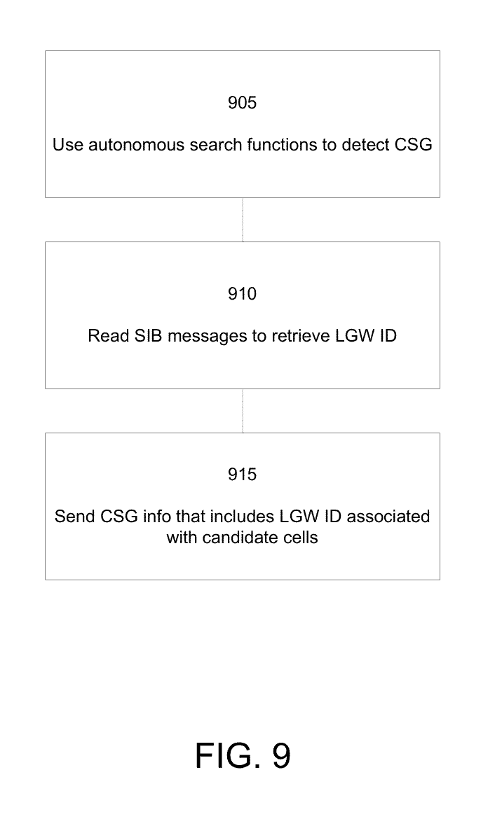

FIG. 9 depicts a method that may be used to inform a mobility management entity (MME) about LGW deployment during a hand off. LGW capabilities may be provided at the target candidate H(e)NB using proximity functions. When a UE may be approaching the coverage area of a H(e)NB, current mobility procedure include the use of proximity indication messages to signal the presence of a H(e)NB network. In an embodiment, a similar procedure be used to signal the presence of H(e)NBs and their LGW capabilities. This information may be useful at the source eNB/H(e)NB to determine whether the target H(e)NB may belong to the same LGW as the source.

For example, as shown in FIG. 9 at 905, upon entering a known location using a location based procedure, the UE may use an autonomous search function to detect CSGs associated to known LGWs. At 910, the UE may read System Information Block messages to retrieve the LGW id associated to a particular CSG or alternative the LGW id associated to the H(e)NB broadcasting the SIB. When the UE is asked to report measurements, at 915, it may include, along with current CSG info, the identity of LGW or LGWs associated to candidate cells for which measurements are reported. Unlike the current R10 procedure whereby proximity is used for UE connected to Macro eNB, the proximity function concept may be extended to H(e)NBs as well. Thus a UE may provide proximity indications also to H(e)NBS to signal the characteristics or capabilities of surrounding H(e)NB with regards to the LGWs they may connect to. As an alternative, if the LGW ids are broadcast by surrounding H(e)NBs, the H(e)NBs themselves may read the LGW capabilities of the surrounding H(e)NBs without the need for reports from the UE. However this may assume that the H(e)NB has a receiver that may tune to both UEs and H(e)NBs. In addition, if the H(e)NB is connected to a H(e)NB GW, the H(e)NB GW may compile the LGWs capabilities of Connected H(e)NBs as part of the E-RAB to be set up list where the LGW Id characteristics could be retrieved. This may occur, for example, upon receipt of the INITIAL CONTEXT SETUP message. The H(e)NB may use the LGW information from target H(e)NBs to determine, whether SIPTO or LIPA handover may proceed.

LIPA/SIPTO user plane data and resources may be handled during and after HO-buffering, path-switching, and resource release at source HeNB. DL LIPA/SIPTO traffic may be buffered during HO. The source HeNB may inform the LGW about the start of a HO and the LGW may start buffering of DL packets for the given UE. The source HeNB may inform the LGW about the chosen target HeNB (e.g. global cell ID, physical cell ID, CSG ID, access mode, etc) and the LGW may later use this information to verify any request from the target HeNB to switch the path towards it (i.e. the target HeNB). In addition to this, the source HeNB may also perform buffering of the LIPA/SIPTO data, regardless if buffering may also done at the source HeNB.

After termination of the HO, the source HeNB may forward LIPA/SIPTO packets to the target, either via the SGW (indirect forwarding path) or via the X2 interface (direct forwarding path). If this is done, the source HeNB may tag the forwarded packets to be LIPA/SIPTO or as packets that may on the direct path from the LGW. The source HeNB may also tag any CN forwarded packets that may have been buffered in the HeNB, such as packets that may not coming directly from the LGW.

The source HeNB may inform the LGW about the initiation of a HO procedure, or the failure of a HO procedure, or the abort of a HO procedure. As such, the LGW may decide to stop buffering packets and may continue forwarding the packets to the source HeNB. This may occur, for example, upon abort of HO or failure of HO that the UE may have returned to the source HeNB cell.

The termination of the buffering at the LGW may be signaled explicitly by the source HeNB after the HO completed. Alternatively, the LGW may conclude the termination of buffering when it receives a request from the target HeNB (or MME, SGW, source HeNB) to switch the data path towards the LGW.

If the bearers that go directly towards the LGW (LIPA or SIPTO@LG packets) are not admitted in the target, the source HeNB may still forward any buffered packets even though the path from the LGW to the target may not be created. This may be done via the SGW as a way to maintain LIPA or SIPTO@LGW session continuity even if the UE has moved to another HeNB that may not connect to the LGW. Moreover, this may be used for outbound mobility where a UE may be handed over from the HeNB subsystem to a macro cell. The forwarding may be done via the SGW and the LIPA/SIPTO@LGW packets may be treated on the default bearer of an existing CN PDN connection, such as on the S1-U and radio bearer that correspond to the default bearer of the UE's CN PDN connection.

A data path may be switched from LGW after HO. A patch switch may occur with S1 HO. The target HeNB may perform the path switch towards the LGW. This may assume that there is a connection between the target HeNB and the LGW, and that at least one LIPA or SIPTO@LGW bearer has been admitted in the target HeNB. The trigger to initiate the path switch may be the reception of the first RRC message after HO e.g. RRCConnectionRconfigurationComplete. The target HeNB may provide a list of bearers that may be admitted and a list of bearers that may have been released along with the cause for the release. The LGW may then release the bearers that were tagged as released by the target HeNB. The path switch may be done via the Sxx interface or any other interface that may be defined between the LGW and a HeNB.

Alternatively, the target HeNB may send the a Handover Notify (S1AP) message to the MME including all the bearers that may be admitted or released. The target HeNB may tag these bearers as being LIPA or SIPTO@LGW. Moreover, the target HeNB may include at least one DL TEID that may be used by the LGW for forwarding DL LIPA/SIPTO@LGW traffic, together with any other addressing information that may be needed to maintain LIPA/SIPTO@LGW service. The MME may in turn send the Modify Bearer Request message to the SGW. In this message, the MME may indicate bearers from the LGW that may have been admitted and all those that may have been released. The MME may also indicate if these are LIPA or SIPTO@LGW bearers. With this information, the SGW may also initiate a Modify Bearer Request message to the LGW to inform the LGW about the path switch towards the target HeNB. It may be possible that no bearer from the LGW is admitted. In this case, MME may initiate the release of the PDN connection towards the LGW.

When the LGW receives an indication of the path switch request or release of PDN connection after the HO, the LGW may also initiate the release of resources towards the source HeNB. The source HeNB may also release resources towards the LGW if the source HeNB may know the bearers that were admitted by the target. For example, the HeNB may verify the HO Command message on the S1AP interface, such as the bearers to be released. Resources between the source HeNB and the LGW may be released after the HO in preparation for any HO failure thereby allowing the UE to continue its LIPA/SIPTO@LGW service from the source HeNB if the UE returns to that cell. This may occur regardless of what node initiates the release of the resources between the source HeNB and the LGW.

After the HO is completed, the resources between the LGW and the source HeNB may be released by either the source HeNB, the LGW, or this may be initiated by the MME/SGW. The resources between the source HeNB and the LGW may be released using messages on either the Sxx interface, or any other interface that may connect both nodes together. If this interface is S1 or X2, existing or new messages may be defined and used for this purpose.

A cause code may be included to explain why any resources may be released. For example, a cause code defined as “HO completed successfully” may be used when releasing HeNB-LGW resources after the successful completion of the HO.

In any stage of the HO, if a target indicates that it may not admit LIPA/SIPTO@LGW bearers due to e.g. lack of connection to the LGW, the source HeNB may save this information for use in subsequent HOs for this UE or any other UE. This may also apply to X2 handovers.

When the LGW receives an indication to switch the path from any node (e.g. from the target HeNB), the LGW may verifies the integrity of the HO. This may be done by, for example, by checking if the source HeNB has already flagged a possible HO, or by probing the source HeNB to verify that a HO may be taking place for the UE in question. The node requesting the path switch may include the necessary information to identify the source node and the LIPA/SIPTO@LGW service for the UE in question. If the information provided does not match that of the LGW, the LGW may reject the path switch request and inform the source HeNB about the HO failure. The LGW may also inform the MME/SGW about the HO failure or path switch failure, and the MME may inform the source HeNB about the HO failure. The HO may be reinitiated if necessary or the UE may resume in the source HeNB if the radio conditions allow for so. The embodiments described above may also apply if the HO is executed via the X2 interface.

A data path may be switched from LGW after HO. A patch switch may occur with X2 HO. The target HeNB may directly contact the LGW to perform the path switch as described for the case of S1 HO above. Thus, the same embodiments may be used with X2 HO. Alternatively, the patch switch request from the target HeNB may go to the MME. This may trigger the Modify Bearer Request towards the SGW, which may send the Modify Bearer Request message towards the LGW. The embodiments defined above in S1 HO, regarding contents and actions of the recipient nodes, may also apply for X2 handover.

Resources may be released between source HeNB and LGW after HO. Resources between the source HeNB and the LGW by released after the HO completion. The resource may be released by either the source HeNB or the LGW. Such a release may be triggered by the SGW or the MME. For example, if during the HO the MME/SGW sends a Modify Bearer Request to the LGW to release a subset of bearers due to HO to a target HeNB, the LGW may interpret this message as completion of the HO towards the target. Since, regardless of whether or not LIPA/SIPTO@LGW bearers were transferred to the target HeNB, HO completion to target may not use resources setup between the source HeNB and the LGW, the LGW may use this message as a trigger to initiate the release of resources towards the source HeNB.

If the LGW was informed about a potential HO as proposed earlier, the LGW may start a timer to guard the duration of a successful HO. If the timer expires at the LGW and it has not received any indication about path switch, release or resumption of the service from any of the nodes (source HeNB, target, or MME/SGW), the LGW may autonomously release the resources for this UE. It may also initiate the deactivation of the PDN connection towards the MME and may release resources towards the source HeNB. A cause code may be included in any message towards any recipient (MME/SGW or source/target HeNB) to explain the reason why the release was initiated.

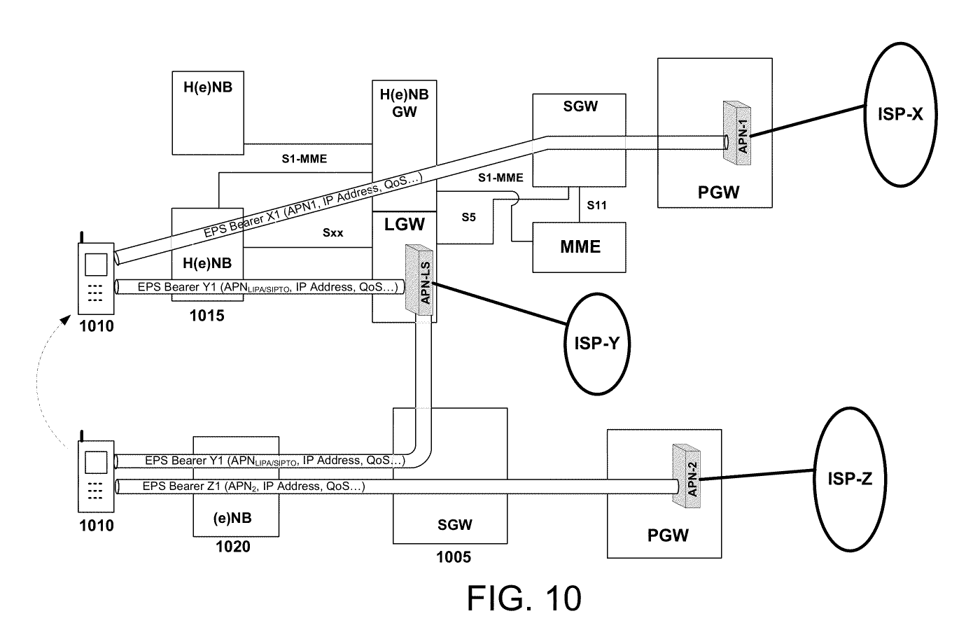

FIG. 10 depicts a communications network that may handle release LIPA and/or SIPTO resources between a source H(e)NB and a LGW after a hand off. An UE origination IP address may be preserved when HO across multiple LGW/PGW. This may occur, for example, during the establishment of an initial PDN connection associated to the Initial System Attach or subsequent Dedicated PDN Connections.

A MME may instruct the SGW, to set up an offload point different associated to either the SGW itself or any other selected PGW. The instructions may be based on, for example, location information, such as TAI, CSG or any other location tag. As shown in FIG. 10, MME 1000 may select an Anchor GW (AGW) or offload point from a pool of available AGW and may communicate this information to the PGW through the CREATE SESSION REQUEST message. The PGW may then relay the CREATE SESSION REQUEST message to the AGW and may provide its own address (the PGW address).

In another embodiment, MME 1000 may request the SGW 1005, through a CREATE SESSION REQUEST message, to select an AGW that may be associated to SGW 1005. Using a CREATE SESSION REQUEST message, SGW 1005 may request a PDN Connection from the AGW and may provide its own address (the SGW 1005 address).

The SGW or PGW address may be used, if UE 1010 needs to be HO back to the macro network. The IP Address provided to UE 1010 may be the IP address of the AGW. When UE 1010 moves between H(e)NB, such as H(e)NB 1015 and H(e)NB 1020, or between H(e)NB connected to different LGW or PGW, the Data path may be established to either the relevant SGW or another LGW.

Addressing information may be exchanged between LGW and HeNBs. For each established EPS bearer and the associated direct path (for LIPA/SIPTO@LGW traffic), there may be two associated directional tunnels between the LGW and the HeNB; the direct path DL tunnel from the LGW to the HeNB, and the direct path tunnel from the HeNB to the LGW (UL tunnel). HeNBs and LGWs may exchange the TEIDs in several ways. Exchange of DL TEID and UL TEID may occur over the Sxx interface using a new Sxx AP (Application) procedure and a procedure in the GTP control plane (GTP-C) assuming a GTP protocol is used over the new Sxx interface. Exchange of DL and TEID over S1-S5 interface, for example over the path H(e)NB<->SGW<->LGW, using a S1 AP application (H(e)NB<->SGW), RANAP procedure (H(e)NB<->SGW), or GTP-C procedure (SGW<->LGW), or a combination thereof. For example the H(e)NB may provide the DL TEID in the Path Switch Request (or Enhanced Relocation Complete Request) message to the MME (or to the MSC/SGSN) that may then be forwarded to the SGW over the S11 interface (Modify Bearer request message). In turn, it may be passed along to the LGW over the S5 interface (Modify Bearer request message).

For the intra-LGW handover scenario, this procedure may be initiated by the source HeNB as soon as after sending the Handover Request or the Enhanced relocation Request to the target HNB. One benefit of sending the message early is that it may allow the LGW to be informed to the fact that a handover procedure is under progress. This may allow the LGW to start taking action, such as buffering DL traffic data. The procedure may also be initiated by the source at a later stage of the handover. The procedure may be initiated by the target upon receiving the Handover Request (or Enhanced Relocation Request) message. The procedure may be initiated at a later stage of the handover procedure, such as upon detecting the UE synchronization or receiving the RRC Connection reconfiguration complete (RRC RB Reconfiguration complete) message. For the inter-LGW handover scenario, the procedure may be initiated by the target HeNB in a similar way as the intra-LGW case.

In another embodiment, a correlation ID may be provided by the LGW to the SGW (Modify bearer response), which may then forward the information to the MME (Modify bearer response). The MME may forward the information to the target HNB using the path switch acknowledge message. The Correlation ID may then be used to correlate the H(e)NB<->SGW<->LGW tunnels to the direct path tunnels between the H(e)NB and the LGW. For example, the Correlation ID may be used for future path management or bearer management exchanges between the H(e)NB and the core network.

A UE may be paged for DL LIPA/SIPTO@LGW traffic. The UE may be informed that a paging in idle mode may be due to LIPA/SIPTO@LGW. Based on this indication, the UE may display to the user/upper layers that there is a paging from the LGW. The UE may optionally also display details on the type of the service e.g. LIPA vs. SIPTO and information about the calling entity, such as some type of identification that may be provided by the LGW. The user may then accept or reject the paging before allowing any session to continue from the LGW.

When downlink packets arrived at the HeNB, the GW/LGW/SGW ensemble (for simplicity referred to as HGW) determines whether a correlation ID or DL TEID S1 connection exists. If a connection does not exist, the HGW may generate a PAGE message toward the HeNB(s) for which CSG Id or PLMN may allow SIPTO or LIPA services. The HGW may generate a Page message according to a configuration choice at the HGW. Paging the HeNB with CGS Id that do not allow LIPA or SIPTO may be wasteful, as the call cannot be set up. If a connection does not exist, the HGW may send a DOWNLINK DATA NOTIFICATION message to the MME to trigger paging. This may assume that the HGW may provide SGW functionality and there may not be a need to send the Downlink Data to a SGW as per current R10 procedures. If the HGW sends first packet to the SGW to trigger a paging procedure it may eventually triggering a PAGING message from the MME to the HGW. Before the MME pages the UE, it may remove CSG Id for which SIPTO and LIPA are not allowed. Alternatively, in case where SGW functionality may not provided by the HGW or LGW, MME may only send the paging message to the HeNBs that it knows are connected to the LGW.

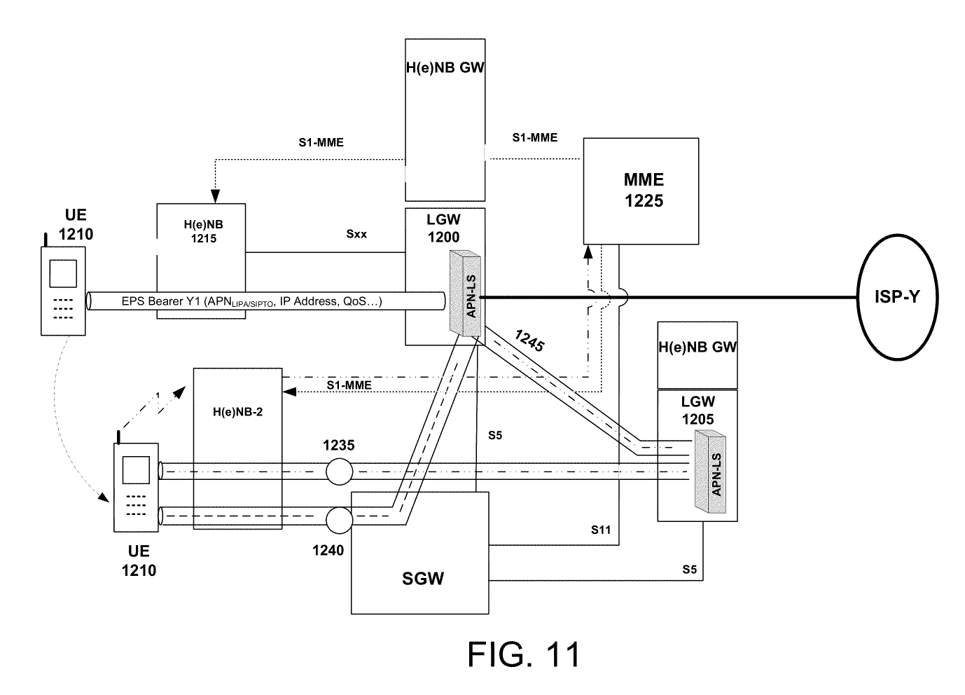

FIG. 11 depicts a communications network that may page a UE for LIPA and/or SIPTO at LGW traffic. The MME may indicate to the HeNB whether the Page is intended to setup LIPA/SIPTO services (i.e., establish a LIPA/SIPTO PDN connection). The HeNB may send this flag/indicator in the Paging message. Based on the LIPA/SIPTO indicator being passed along within the Paging message, the UE may display, for example, whether the call is intended to set up a LIPA or SIPTO connection. The UE may also display Calling Line ID information. The user may indicate his desire to reject or allow the call/connection.

If multiple HGW or LGW within an area share HeNB resources from a HeNB or HeNB GW, it may be possible that a UE may answer a page in a HeNB with the same CSG Id, but may connect to a different SGW than the one where the original DL packet was received. To address this scenario, during an initial SLAP setup, the H(e)NB may obtain the address of the LGW or alternatively, the UE may provide the H(e)NB with the LGW id during the RRC CONNECTION REQUEST message. The HeNB may build a list of potential LGWs based on information provided by the MME in for example, the SLAP INITIAL CONTEXT SETUP REQUEST message. During the paging procedure, the HeNB/HeNBGW may provide the MME with the address of the LGW/SGW where packets may be routed within the S1-AP INITIAL UE MESSAGE. The MME may use this information to provide the address of either the SGW that serves the H(e)NB where the page was received or the LGW provided by the H(e)NB to the original LGW. The MME may relay this information, toward the relevant SGW, using a CREATE SESSION REQUEST message. The SGW in turn, may use its own address or provide the address of the LGW-2, such as LGW 1205, within the CREATE SESSION REQUEST message that is relayed to the LGW-1, such as LGW 1200.

As shown in FIG. 11, UE 1210 may be originally connected to H(e)NB 1215 and LGW 1200. While in idle mode, UE 1210 may move to the coverage area of H(e)NB 1220, which may be connected to LGW 1205. Upon receipt of a Paging message, UE 1210 may respond to the page through H(e)NB 1220 and the process may continue as described above. At 1240, MME 1225 may provide the address of SGW 1230. At 1235, MME 1225 may provide the address of LGW 1205.

In case of multiple LGWs, there may be at least a connection between at least two LGWs. This may be done, for example, to ensure that if a HeNB does not connect to LGW 1200, which may be providing LIPA/SIPTO@LGW for a given UE, packets from LGW 1200 may be forwarded via 1245 (the proposed tunnel/connection) to LGW 1205. LGW 1205 may be where the current serving HeNB connects. This may provide another level of LIPA/SIPTO@LGW mobility. For either UL or DL LIPA/SIPTO@LGW data exchange for a UE under the radio coverage of given HeNB that does not connect to LGW 1200, MME 1225 may coordinate the establishment of tunnels between LGW 1200 and LGW 1205. This may be done, for example, to ensure that the desired DL packets are forwarded from LGW 1200 to LGW 1205 at 1245, to HeNB 1220 via 1235, and finally to UE 1210. Any UL packets may be forwarded in reverse order. To coordinate the establishment of a tunnel, the MME may use information about what LGW the current HeNB connects to and what the LGW was providing LIPA/SIPTO@LGW for the UE in question. The MME may trigger the establishment of this tunnel via the SGW, for example, using existing message such as modify bearer request or new messages to the LGWs.

LIPA/SIPTO permissions may be used at HO. Embodiments may take into consideration SIPTO/LIPA permission at the H(e)NB target. For example, the MME or the LGW may decide if the Target Cell/HeNB does not support LIPA/SIPTO services. PLMN-base permission for SIPTO services in target H(e)NB may also be taken in consideration. CSG membership in terms of SIPTO permissions may also be taken into consideration. For example, if the UE is a member of this CSG, the CSG may allow SIPTO services.

A Handover Restriction List may be provided by the MME to the eNB in a HANDOVER REQUEST, an INITIAL CONTEXT SETUP, or a DOWNLINK NAS TRANSPORT message. The handover restriction list may be used to consider HO restrictions due to LIPA or SIPTO permission configuration. An eNB may use this information to remove candidate neighbors even if the UE reported good radio conditions when providing measurement reports. A target eNB may use this information to determine whether the request may be rejected.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for selecting a target HeNB for a handover, the method comprising:
establishing a connection with a wireless transmit/receive unit (WTRU), the connection supporting a session, wherein the session comprises any of a selective IP traffic offload (SIPTO) or local IP access (LIPA) session;
selecting a target HeNB for the handover based on the ability of the target HeNB to support the session; and
handing over the session to the target HeNB.

2. The method of claim 1, wherein selecting a target HeNB for the handover based on the ability of the target HeNB to support the session comprises determining, based on CSG subscription information, that the WTRU is permitted to access the target HeNB.

3. The method of claim 1, wherein selecting a target HeNB for the handover based on the ability of the target HeNB to support the session comprises verifying that the target HeNB is connected to a local gateway (LGW) providing the session for the WTRU.

4. The method of claim 1, wherein selecting a target HeNB for the handover based on the ability of the target HeNB to support the session comprises determining that the WTRU is permitted to receive service from the target HeNB.

5. The method of claim 1, wherein selecting a target HeNB for the handover based on the ability of the target HeNB to support the session comprises:
determining, based on CSG subscription information, that the WTRU is permitted to access the target HeNB;
verifying that the target HeNB is connected to a local gateway (LGW) providing the session for the WTRU; and
determining that the WTRU is permitted to receive service from the target HeNB.

6. The method of claim 1, wherein selecting a target HeNB for the handover based on the ability of the target HeNB to support the session comprises:
receiving a measurement from the WTRU for the target HeNB; and
analyzing the measurement to determine whether radio conditions between WTRU and the target HeNB support the session.

7. The method of claim 1, wherein selecting a target HeNB for the handover based on the ability of the target HeNB to support the session comprises:
receiving an operator policy;
determining one or more conditions that indicate that support for the session using the operator policy; and
determining when the one or more conditions have been met.

8. The method of claim 1, wherein determining when the one or more conditions have been met occurs receiving an operator policy;
determining one or more conditions that indicate that support for the session using the operator policy;
receiving a measurement from the WTRU for the target HeNB, the measurement indicating whether radio conditions between the WTRU and the target HeNB support the session; and
determining when the one or more conditions have been met when the measurement when the measurement indicates that the radio conditions between the WTRU and the target HeNB support the session.

9. The method of claim 1, wherein selecting a target HeNB for the handover based on the ability of the target HeNB to support the session comprises receiving a an indication that the session is supported on the target HeNB from the WTRU

10. The method of claim 1, wherein selecting a target HeNB for the handover based on the ability of the target HeNB to support the session comprises receiving an identity from the target HeNB that specifies a personal data network (PDN) or identifies a LGW.

11. The method of claim 1, wherein selecting a target HeNB for the handover based on the ability of the target HeNB to support the session comprises contacting the target HeNB via an X2 interface.

12. The method of claim 1, wherein selecting a target HeNB for the handover based on the ability of the target HeNB to support the session comprises receiving information from the core network indicating that the target HeNB supports the session.

13. The method of claim 1, wherein selecting a target HeNB for the handover based on the ability of the target HeNB to support the session comprises receiving information from a MME or a LGW indicating that the target HeNB supports the session.

14. The method of claim 1, where in handing over the session to the target HeNB comprises:
determining a LGW transport layer address and a tunnel end point identification (TEID); and
providing the LGW transport layer address and the TEID to the target HeNB to enable the target HeNB to continue the session.

15. The method of claim 1, wherein establishing a connection with a WTRU comprises:
establishing a SCTP association towards a LGW with a predefined STCP destination port number;
transferring support for a downlink TEID to the LGW;
transmitting a HeNB transport layer address; and
receiving a LGW transport layer address.

16. A method comprising:
receiving, via a wireless transmit/receive unit (WTRU), an inter-access point name (APN) routing policy (IARP) that provides a set of rules for routing IP traffic across one or more active interfaces;
determining a preferred APN using a prioritized list of APNs from the IARP;
selecting an IP interface to route an IP flow based on the preferred APN; and
transmitting the IP flow using selected IP interface.

17. The method of claim 16, further comprising transmitting an indication to a network entity that the IP flow is selective IP traffic offload (SIPTO) or local IP access (LIPA).

18. The method of claim 17, wherein the indication comprises IP address information to enable a local gateway (LGW) to identify the IP flow as SIPTO or LIPA.

19. The method of claim 17, wherein the indication comprises an APN value to enable a LGW to identify the IP flow as SIPTO or LIPA.

20. The method of claim 17, wherein the network entity comprises a mobility management entity (MME), a serving gateway (SGW), or a LGW.

21. The method of claim 16, wherein the selected IP interface is a dedicated packet data network (PDN) connection.

22. The method of claim 16, wherein the IARP is received from an access network discovery and selection function (ANDSF).

23. A method for providing a handover, the method comprising:
receiving, via a HeNB, a handover indication;
determining whether a connection with a wireless transmit/receive unit (WTRU) can be established, the connection supporting a session, wherein the session comprises any of a selective IP traffic offload (SIPTO) or local IP access (LIPA) session;
establishing a connection with the WTRU; and
receiving the session handover.

24. The method of claim 23, wherein determining whether a connection with a WTRU can be established comprises:
determining, based on CSG subscription information, that the WTRU is permitted to access the HeNB;
verifying that the HeNB is connected to a local gateway (LGW) providing the session for the WTRU; and
determining that the WTRU is permitted to receive service from target HeNB.

25. The method of claim 24, further comprising transmitting an identity that specifies a personal data network (PDN) or identifies the LGW.

26. The method of claim 24, further comprising transmitting information to a core network indicating that the HeNB supports the session.

27. The method of claim 24, further comprising transmitting information to the WTRU indicating that the HeNB supports the session.

28. The method of claim 23, further comprising determining a LGW transport layer address and a tunnel end point identification (TEID).
